(19) United States
(12) Patent Application Publication
(10) Pub. No.: US 2018/0174101 A1
(43) Pub. Date: Jun. 21, 2018

(54) SYSTEMS AND METHODS FOR STORING AND RETRIEVING MERCHANDISE AT PRODUCT DISTRIBUTION CENTERS

(71) Applicant: Wal-Mart Stores, Inc., Bentonville, AR (US)

(72) Inventors: Todd D. Mattingly, Bentonville, AR (US); Bruce W. Wilkinson, Rogers, AR (US)

(21) Appl. No.: 15/782,555

(22) Filed: Oct. 12, 2017

Related U.S. Application Data
(60) Provisional application No. 62/439,268, filed on Dec. 27, 2016.
(60) Provisional application No. 62/436,842, filed on Dec. 20, 2016.
(60) Provisional application No. 62/485,045, filed on Apr. 13, 2017.

(51) Int. Cl. G06Q 10/08; G06K 7/10

(52) U.S. Cl. CPC G06Q 10/08355; G06K 7/10861; G06K 7/10297; G06Q 10/0833

(57) ABSTRACT

In some embodiments, apparatuses and methods are provided herein useful to storing and retrieving merchandise items in product distribution centers. In some embodiments, there is provide a system including: a distribution center with storage locations holding merchandise items, the merchandise items being arranged according to a predetermined packing plan assigning a unique storage location to each merchandise item; sensor tags associated with the merchandise items; a plurality of routes from the storage locations to a merchandise handling area; a tote for delivering merchandise items from the storage locations to the merchandise handling area; and a control circuit configured to determine a merchandise item to be delivered to the merchandise handling area; communicate with a sensor tag to identify a storage location of the merchandise item; communicate with the tote to move it to the storage location to receive the merchandise item and to move it to the merchandise handling area.

### CROSS-REFERENCE TO RELATED APPLICATION

This application claims the benefit of U.S. Provisional Application No. 62/439,268, filed Dec. 27, 2016, U.S. Provisional Application No. 62/436,842, filed Dec. 20, 2016, and U.S. Provisional Application No. 62/485,045, filed Apr. 13, 2017, which are all incorporated by reference in their entirety herein.

### TECHNICAL FIELD

This invention relates generally to storing and retrieving merchandise items, and more particularly, to storing and retrieving merchandise items at product distribution centers using dense storage.

### BACKGROUND

One important challenge in the retail setting is the storage and retrieval of merchandise at product distribution centers. These distribution centers may be used to store a large quantity of merchandise. Often, this merchandise may be shipped to stores for sale to customers. Alternatively, this merchandise may be shipped by delivery vehicles operated by employees or third party carriers to customers.

In these distribution centers, it is desirable to use such approaches as dense storage to maximize the use of storage space within a distribution center. In this regard, it is desirable to use a well-developed packing plan for organizing this storage space according to various factors. Further, it is desirable to use automated totes to retrieve merchandise from assigned storage locations in the packing plan and deliver the merchandise to handling areas in the distribution center.

### BRIEF DESCRIPTION OF THE DRAWINGS

Disclosed herein are embodiments of systems, apparatuses and methods pertaining to storing and retrieving merchandise items at product distribution centers using dense storage. This description includes drawings, wherein:

FIG. 1 is a schematic representation in accordance with some embodiments;

FIG. 2 is a schematic representation in accordance with some embodiments;

FIG. 3 is a block diagram in accordance with some embodiments;

FIG. 4 is a flow diagram in accordance with some embodiments;

FIG. 5 is a block diagram in accordance with some embodiments;

FIG. 6 comprises a flow diagram as configured in accordance with various embodiments of these teachings;

FIG. 7 comprises a flow diagram as configured in accordance with various embodiments of these teachings;

FIG. 8 comprises a graphic representation as configured in accordance with various embodiments of these teachings;

FIG. 9 comprises a graph as configured in accordance with various embodiments of these teachings;

FIG. 10 comprises a flow diagram as configured in accordance with various embodiments of these teachings;

FIG. 11 comprises a graphic representation as configured in accordance with various embodiments of these teachings;

FIG. 12 comprises a graphic representation as configured in accordance with various embodiments of these teachings;

FIG. 13 comprises a graphic representation as configured in accordance with various embodiments of these teachings;

FIG. 14 comprises a flow diagram as configured in accordance with various embodiments of these teachings;

FIG. 15 comprises a flow diagram as configured in accordance with various embodiments of these teachings;

FIG. 16 comprises a graphic representation as configured in accordance with various embodiments of these teachings;

FIG. 17 comprises a graphic representation as configured in accordance with various embodiments of these teachings;

FIG. 18 comprises a block diagram as configured in accordance with various embodiments of these teachings;

FIG. 19 comprises a flow diagram as configured in accordance with various embodiments of these teachings;

FIG. 20 comprises a graph as configured in accordance with various embodiments of these teachings;

FIG. 21 comprises a flow diagram as configured in accordance with various embodiments of these teachings; and

FIG. 22 comprises a block diagram as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful to storing and retrieving merchandise items at product distribution centers. In some embodiments, there is provided a system including: a distribution center with a plurality of storage locations holding a plurality of merchandise items, the plurality of merchandise items being arranged in the plurality of storage locations according to a predetermined packing plan, the plan assigning a unique storage location to each merchandise item; a plurality of sensor tags associated with the plurality of merchandise items, each sensor tag being associated with a type of merchandise item; a plurality of routes from the plurality of storage locations to at least one merchandise handling area; at least one tote configured to deliver merchandise items from the plurality of storage locations to the at least one merchandise handling area; a first control circuit operatively coupled to the plurality of sensor tags and to the at least one tote, the first control circuit configured to: determine a first type of merchandise item to be delivered to the at least one merchandise handling area; communicate with a first sensor tag to identify a first storage location of the first type of merchandise item; communicate with a first tote to move the first tote to the first storage location to receive the first type of merchandise item; and communicate with the first tote to move the first tote to the at least one merchandise handling area; wherein the plurality of storage locations in the predetermined packing plan are arranged based on at least one of merchandise item type, customer information, delivery distance, projected storage time, delivery time, and weather.

In one form, in the system, the plurality of storage locations may be arranged in at least one storage unit having a plurality of compartments, each compartment having unique coordinates to identify the location of the compartment within the at least one storage unit. Further, in the system, the at least one tote may include a second control circuit configured to: receive a communication from the first control circuit regarding the first storage location of the first type of merchandise item; and determine a route to the first storage location and move the tote to the first storage location. In addition, the at least one tote may further include a sensor and the second control circuit may be configured to: communicate with a database to determine a first identifier for the first type of merchandise item; and actuate the sensor to compare a second identifier for a merchandise item received at the first storage location with the first identifier to verify that the merchandise item received is of the first type.

In one form, in the system, the first control circuit may be configured to: determine a second type of merchandise item to be delivered to the at least one merchandise handling area; communicate with a second sensor tag to identify a second storage location of the second type of merchandise item; and communicate with the first tote to move the first tote from the first storage location to the second storage location to receive the second type of merchandise. Also, the at least one tote may further include a two-way wireless communications component that is attached to the tote and configured to receive information regarding a first planned automated route for the at least one tote to the first storage location. Moreover, the two-way wireless communications component may be configured to receive information regarding the first type of merchandise item planned to be placed in the at least one tote at the first storage location. In addition, the at least one tote may further include a first sensor to verify contents or condition of the first type of merchandise item planned to be placed in the at least one tote. Further, the at least one tote may also include a second sensor for reading the first sensor tag to determine the identity of the first type of merchandise item in the first storage location; and the two-way wireless communications component may be configured to transmit the read information to the control circuit to verify that the first type of merchandise item is in the corresponding storage location according to the predetermined packing plan. Additionally, the two-way wireless communications component may be configured to receive information regarding a second planned automated route for the at least one tote to the at least one merchandise handling area.

In one form, the system may further include an unloading apparatus configured to transport the first type of merchandise item from the first storage location to the first tote. Also, in the system, the predetermined packing plan may be determined based on customer preferences. Moreover, the first control circuit may be configured to: access partiality information for customers and to use that partiality information to form corresponding partiality vectors for customers wherein the partiality vector has a magnitude that corresponds to a magnitude of the customer's belief in an amount of good that comes from an order associated with that partiality. In addition, the first control circuit may be further configured to: form counterpart merchandise item vectors wherein the counterpart vectors have a magnitude that represents to the degree which each of the merchandise items pursues a corresponding partiality. Additionally, the first control circuit may be further configured to: use the partiality vectors and the merchandise item vectors to determine the predetermined packing plan. Further, in the system, the plurality of sensor tags may include RFID tags or barcodes.

In another form, there is provided a method for storing and retrieving merchandise items in distribution centers, the method including: providing a distribution center with a plurality of storage locations holding a plurality of merchandise items; arranging the plurality of merchandise items in the plurality of storage locations according to a predetermined packing plan, the plan assigning a unique storage location to each merchandise item, the arrangement of the plurality of storage locations being based on at least one of merchandise item type, customer information, delivery distance, projected storage time, delivery time, and weather; associating a plurality of sensor tags with the plurality of merchandise items, each sensor tag being associated with a type of merchandise item; providing a plurality of routes from the plurality of storage locations to at least one merchandise handling area; providing at least one tote configured to deliver merchandise items from the plurality of storage locations to the at least one merchandise handling area; identifying a first type of merchandise item to be delivered to the at least one merchandise handling area; communicating with a first sensor tag to identify a first storage location of the first type of merchandise item; communicating with a first tote to move the first tote to the first storage location to receive the first type of merchandise item; and communicating with the first tote to move the first tote to the at least one merchandise handling area.

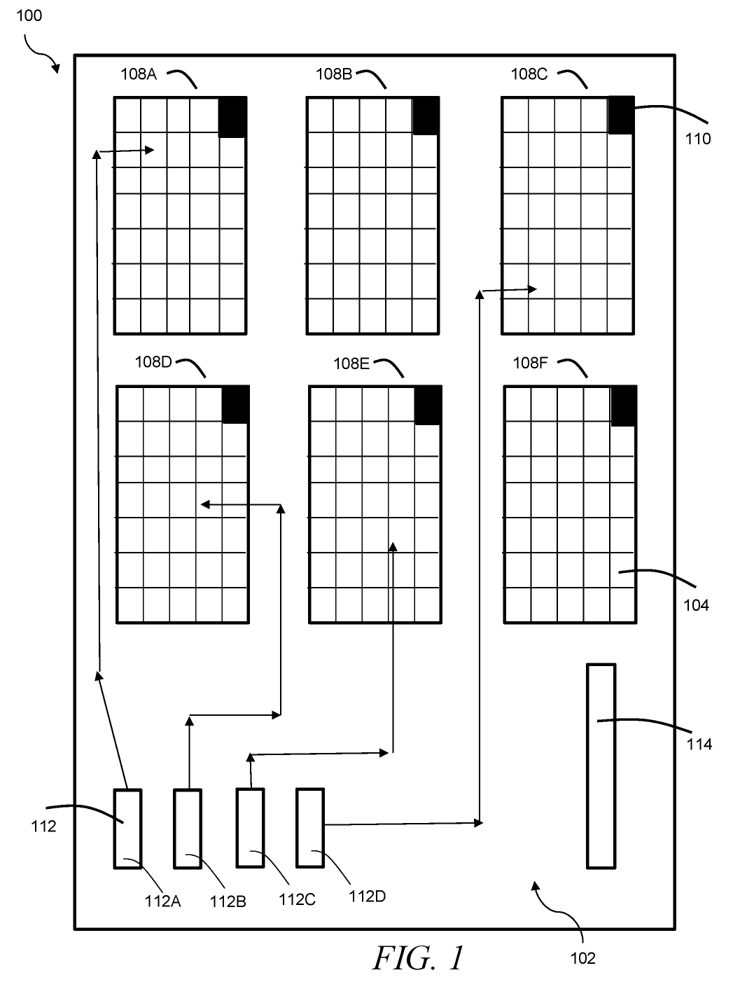

Referring to FIG. 1, there is shown a schematic representation of a system 100 using totes to transport merchandise to a merchandise handling area in a product distribution center. The system 100 preferably uses the concept of dense storage to maximize the use of space in the product distribution center. The merchandise is stored according to a certain, predetermined merchandise packing plan, which, as addressed below, may be arranged according to various factors.

In one form, as addressed further below, this system 100 is contemplated for densely packing, storing and retrieving “eaches” in a distribution center. In a traditional distribution center, packages/containers of items/products are stored, transported, etc. through the distribution center. In system 100, the packages/containers are preferably broken down into “eaches”—individual items/products. The system 100 stores these eaches and allows them to be retrieved to fulfill orders for delivery.

In one form, in summary, eaches are preferably stored in densely packed storage units having compartments or cartridges, the compartments having coordinates (x, y, z) within the space of the storage unit. In one form, the storage unit may resemble a vending machine containing the eaches and allowing them to be packed and/or retrieved via a robotic and/or human mechanism. In this form, eaches may be densely packed into corresponding cartridges and their location may be recorded according to a packing plan. The packing plan may be optimized based on item type, customer information, delivery distance, projected storage time, delivery time, and/or weather. In this form, the packing plan may define the items for a compartment and storage location (x, y, z) of items in each compartment. Eaches removed from the storage unit may be retrieved and added to totes for delivery and added to customer orders. The system 100 may accommodate various types of items, including fragile, refrigerated, frozen, ambient, and bulk items. Fragile and perishable items may be stored in compartments that are refrigerated, or may be stored in separate storage units for human retrieval and integration/addition to robotically retrieved customer orders and totes.

FIG. 1 shows a distribution center 102 with storage locations 104 for holding merchandise items 106 with the merchandise items 106 being arranged in the storage locations 104 according to a certain packing plan In one form, it is generally contemplated that the plan assigns a unique storage location 104 to each merchandise item 106. So, for example, in FIG. 1, there are shown six individual dense storage units 108A-F with each dense storage unit 108A-F having 35 separate storage locations 104. In other words, the storage locations 104 may be arranged in a storage unit 108A having a plurality of storage locations/compartments with each compartment having unique coordinates to identify the location of the compartment within that storage unit 108A.

In this example, according to the packing plan, the six individual dense storage units 108A-F may include different types of merchandise, such as, without limitation, refrigerated produce (108A), frozen grocery (108B), apparel (108C), sporting goods (108D), electronic devices (108E), and outdoor/yard/gardening goods (108F). In one form, different storage units may be maintained at different temperatures depending on the nature of the merchandise stored in a particular storage unit (i.e., refrigerated produce, frozen goods, etc.). As is evident, there are many different possible numbers and arrangements of dense storage units in a distribution center 102.

In the system 100, sensor tags 110 are associated with merchandise items 106 such that each sensor tag 110 is associated with a type of merchandise item 106. So, for example, in FIG. 1, there is a sensor tag 110 at each dense storage unit 108A-F with each sensor tag 110 being associated with a different type of merchandise. However, this is just one example of an arrangement, and there are many other alternative ways of arranging sensor tags 110. In another example, a sensor tag 110 may be mounted at each individual storage location 104 (or compartment) or may be mounted on each merchandise item 106 itself at each individual storage location 104. The sensor tags 110 may be any of various types so as to identify a unique location or different types of merchandise, such as RFID tags or barcodes.

The system 100 also includes totes 112 configured to deliver the merchandise items 106 from the storage locations 104 to a merchandise handling area 114. So, for example, in FIG. 1 there is shown four totes 112A-D that are intended to travel to storage locations 104 corresponding to merchandise items 106 to receive the merchandise items 106 and to transport the merchandise items 106. The totes 112 can receive and deliver one merchandise item 106 to the merchandise handling area 114 during one trip or can travel to multiple storage locations in one trip to receive multiple merchandise items 106 that are then delivered to the merchandise handling area 114. The totes 112 may be any of various physical structures with various components, such as number and type of merchandise holding areas, holding capacities, legs, wheels, etc. The operation of these totes 112 is described in greater detail below.

The system 100 may further include a number of routes that the totes 112 may navigate and travel to and from the storage locations 104. So, for example, in FIG. 1, there is illustrated four separate routes that the four totes 112A-D may travel to four different storage locations 104. In addition, the totes 112 may travel a number of routes from the storage locations 104 to the merchandise handling area 114. In one form, the system 100 may use the sensor tags 110 as an aid in navigation. Further, in addition to sensor tags 110, the system 100 may use any of a variety of indoor positioning and navigation techniques, such as, without limitation, GPS, WiFi indoor positioning, ultra-wideband, RFID, and image-based technologies identifying visual cues.

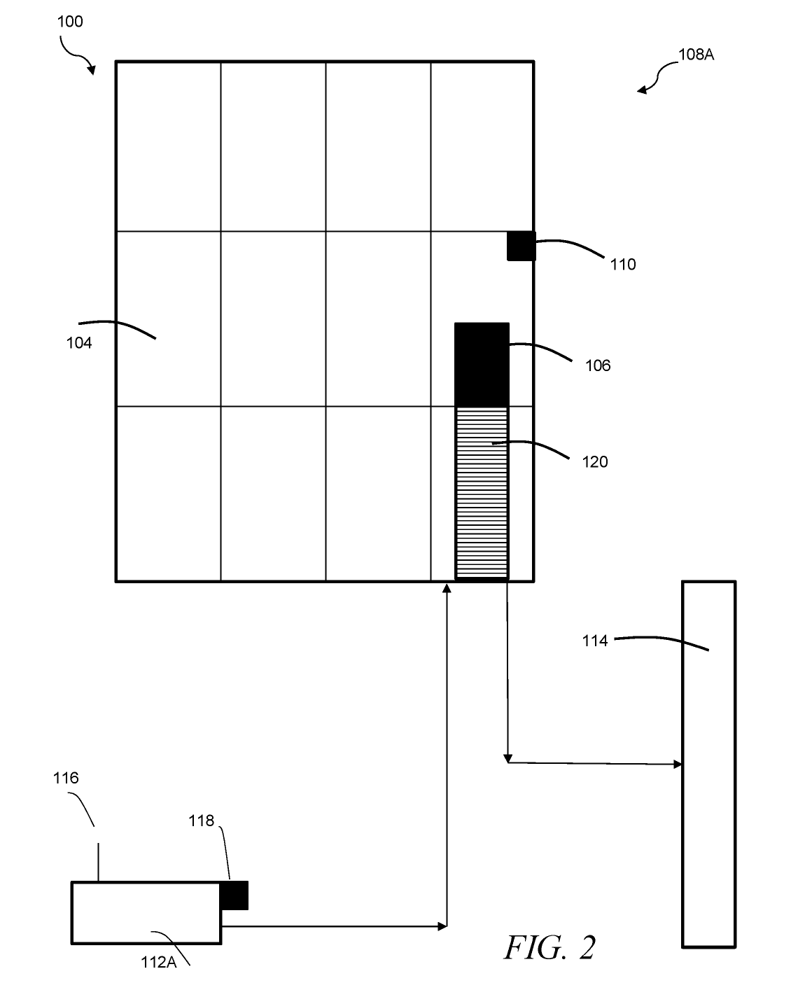

FIG. 2 focuses on a portion of the system 100. More specifically, FIG. 2 shows one of the totes 112A traveling to one of the dense storage units 108A, receive a merchandise item 106 from a storage location 104, and then transporting the merchandise item 106 to the merchandise handling area 114. In this form, the tote 112A may include a two-way wireless communications component 116 for communicating with a remote control circuit (such as described below) and may include one or more sensors 118. As described further below, it is generally contemplated that the tote 112A may include any of various types of sensors 118, such as, without limitation, image capture devices and barcode/RFID readers. For example, image capture devices (including, without limitation, any of various types of cameras or video devices) could be used to capture and compare images to verify the contents and condition of the merchandise item 106 or could be used to identify the merchandise item 106. Additionally, barcodes/RFID readers may be used to scan/read barcodes or RFID sensor tags 110 to identify the merchandise item 106. Further, obstacle sensors (such as, without limitation, laser sensors) may be used to aid navigation and avoid obstacles. As should be understood, other sensors may be used in lieu of or in addition to those mentioned.

As shown in FIG. 2, the tote 112A travels to a dense storage unit 108 and receives a merchandise item 106. In this example, the storage location 104 may have a sensor tag 110 associated with it. In one form, it is generally contemplated that some form of unloading apparatus 120 may be used to unload the merchandise item 106 from the storage location 104 to the tote 112A. In other words, an unloading apparatus 120 may be configured to transport merchandise from the storage location 104 to the tote 112A, and the unloading apparatus 120 may be any of various forms. In one form, as shown in FIG. 2, the unloading apparatus 120 may be in the form of an elevator or lifting/lowering mechanism. In another form, the unloading apparatus 120 may be in the form of an autonomous or semi-autonomous mobile robot vehicle and/or robot arm that can move the merchandise item 106 to the tote 112A. In yet another form, the dense storage unit 108 may be comparable in form to a vending machine, and the unloading apparatus 120 may be in the form of one or more slides, chutes, conveyors, lifts, passageways, etc. that can be used, alone or in combination, to define a path from the merchandise item 106 to the tote 112A.

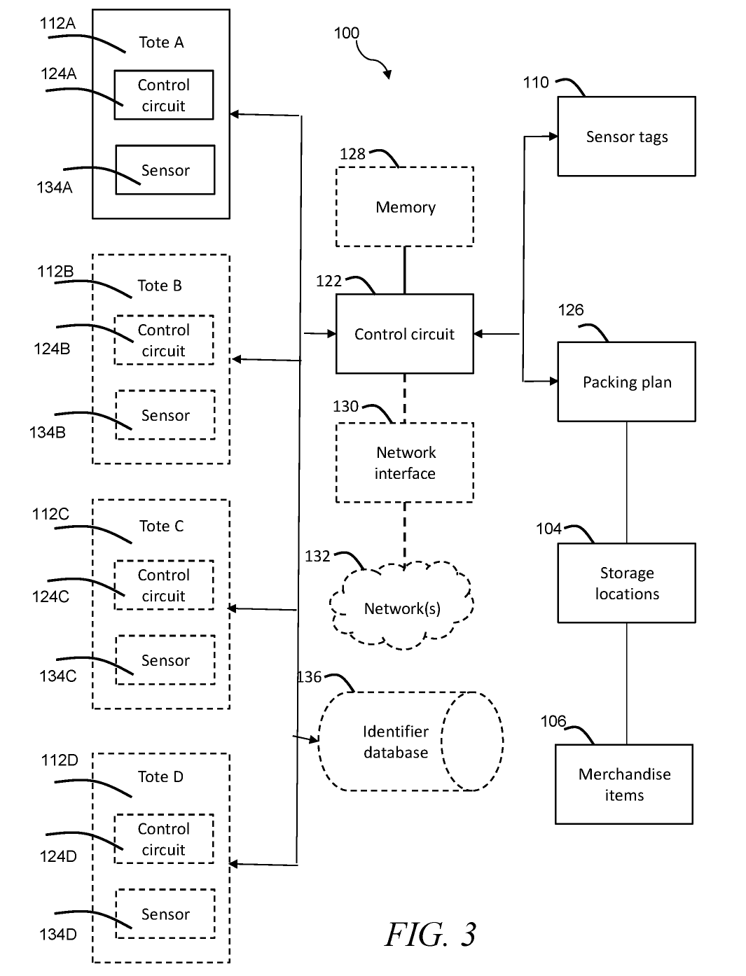

FIG. 3 shows additional components of the system 100 for storing and retrieving merchandise items 106 in distribution centers 102. As can be seen, there is shown a general control circuit 122 that controls the overall operation of the system 100. In this form, the control circuit 122 is in communication with one or more “smart” totes 112A-D, which, in turn, have their own control circuits 124A-D that control navigation and operation of the totes 112A-D. As addressed further below, these control circuits 124A-D are intended to allow local distribution of intelligence and data in the system 100. The general control circuit 122 is also coupled to the sensor tags 110 in order to communicate and direct the “smart” totes 112A-D to storage locations 104 containing merchandise items 106 arranged in accordance with the packing plan 126.

As described herein, the language “control circuit” refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuits 122 and 124A-D may be configured (for example, by using corresponding programming stored in a memory as will be well understood by those skilled in the art) to carry out one or more of the steps, actions, and/or functions described herein.

As shown in FIG. 3, the control circuit 122 is coupled to a memory 128 and may be coupled to a network interface 130 and network(s) 132. The memory 128 can, for example, store non-transitorily computer instructions that cause the control circuit 122 to operate as described herein, when the instructions are executed, as is well known in the art. Further, the network interface 130 may enable the control circuit 122 to communicate with other elements (both internal and external to the system 100). This network interface 130 is well understood in the art. The network interface 130 can communicatively couple the control circuit 122 to whatever network or networks 132 may be appropriate for the circumstances. The control circuit 122 may be in communication with a server of the distribution center 102 and/or may make use of cloud databases and/or operate in conjunction with a cloud computing platform. It is further contemplated that the control circuits 124A-D of the “smart” totes may make use of such components to operate in a similar manner.

The control circuit 122 is configured to interact with the tote(s) 112A-D and sensor tags 110. The control circuit 122 determines a type of merchandise item 106 to be delivered to the merchandise handling area 114. It communicates with a sensor tag 110 to identify a storage location 104 of that type of merchandise item 106. In one form, it is contemplated that the control circuit 122 may look up the storage locations 104 in memory 128 (or in a separate database) based on their assigned locations within the packing plan 126 and that the control circuit 122 may then communicate with a corresponding sensor tag 110 to confirm this assigned storage location 104. The control circuit 122 communicates with a tote 112A to move the tote 112A to the storage location 104 to receive the merchandise item 106 and also communicates with the tote 112A to move it to the merchandise handling area 114. In one form, this communication may simply constitute identifying the merchandise items 106 to be retrieved, and the local control circuits 124A-D may then determine the storage locations 104, the navigation to each storage location 104, and the navigation to the merchandise handling area 114.

The sensor tags 110 may be used for a variety of functions, such as to: confirm the identity of the merchandise 106 at a storage location 104, facilitate navigation to the storage location 104, and/or confirm the type of merchandise 106 once a tote 112A-D arrives at the storage location 104. The sensor tags 110 may be used to perform some or all of these functions. For example, in one form, the sensor tag 110 might be used only to confirm the type of merchandise 106 following arrival of a tote 112A-D. In this example, the packing plan 126 might provide sufficient initial information of the identity of merchandise 106 at the storage location 104, and navigational aids other than the sensor tags 110 may be used to guide a tote 112A-D to a correct storage location 104.

It is generally contemplated that the local control circuits 124A-D may be configured in various ways to provide the totes with a desired level of “smartness.” For example, in one form, it is generally contemplated that the general control circuit 122 need only communicate certain general instructions to the “smart” totes 112A-D and that the “smart” totes 112A-D will then be able to operate independently. As addressed above, in one form, the general control circuit 122 need only communicate the merchandise item(s) 106 to be retrieved by the tote 112A, and the local control circuits 124A-D may then retrieve the needed information and calculate routes. However, in another form, the general control circuit 122 may communicate each time the tote 112A needs to move to a new storage location 104 and/or to the merchandise handling area 114. In yet another form, as described further below, the general control circuit 122 may itself look up storage locations 104 and communicate these specific coordinates to the tote 112A. Further, optionally, the general control circuit 122 may calculate and communicate a specific navigational route to the storage locations 104 and/or merchandise handling area 114.

So, in one form, it is generally contemplated that the local control circuits 124A-D provide the “smart” totes 112A-D with a great deal of independent operation. For example, in one form, the local control circuits 124A-D may be configured to receive communication(s) from the general control circuit 122 regarding storage location(s) 104 of merchandise item(s) 106 and to determine routes to storage location(s) 104 and move the tote(s) 112A-D to the storage location(s) 104. Further, in one form, each tote 112A-D may include a sensor 134A-D for scanning/reading sensor tags 110. The local control circuits 124A-D may be configured to communicate with a product identifier database 136 to determine identifier(s) for merchandise item(s) 106 and to actuate the sensor 134A-D to compare an identifier (such as a barcode or an RFID tag) for a merchandise item 106 received at a storage location 104 with an identifier retrieved from the database 136 to verify that the merchandise item 106 received by the tote(s) 112A-D is of the correct, intended type. It is generally contemplated that the database 136 may be a locally stored database at the tote 112A-D or that it may be a remote database (which the local control circuits 124A-D may access via wireless communication).

It is also contemplated that more than one merchandise item 106 may be retrieved by a tote 112A before it travels to the merchandise handling area 114. In other words, the tote 112A may travel from one storage location to other storage location(s) before dropping off the merchandise items 106 at the merchandise handling area 114. In one form, this multi-stop approach may be instructed through the general control circuit 122. For example, after a first type of merchandise item 106 is retrieved from a first storage location 104, the general control circuit 122 may determine a second type of merchandise item 106 to be delivered to the merchandise handling area 114, communicate with a second sensor tag 110 to identify a second storage location 104 of the second type of merchandise item 106, and communicate with the tote 112A to move the tote 112A from the first storage location to the second storage location 104 to receive the second type of merchandise 106.

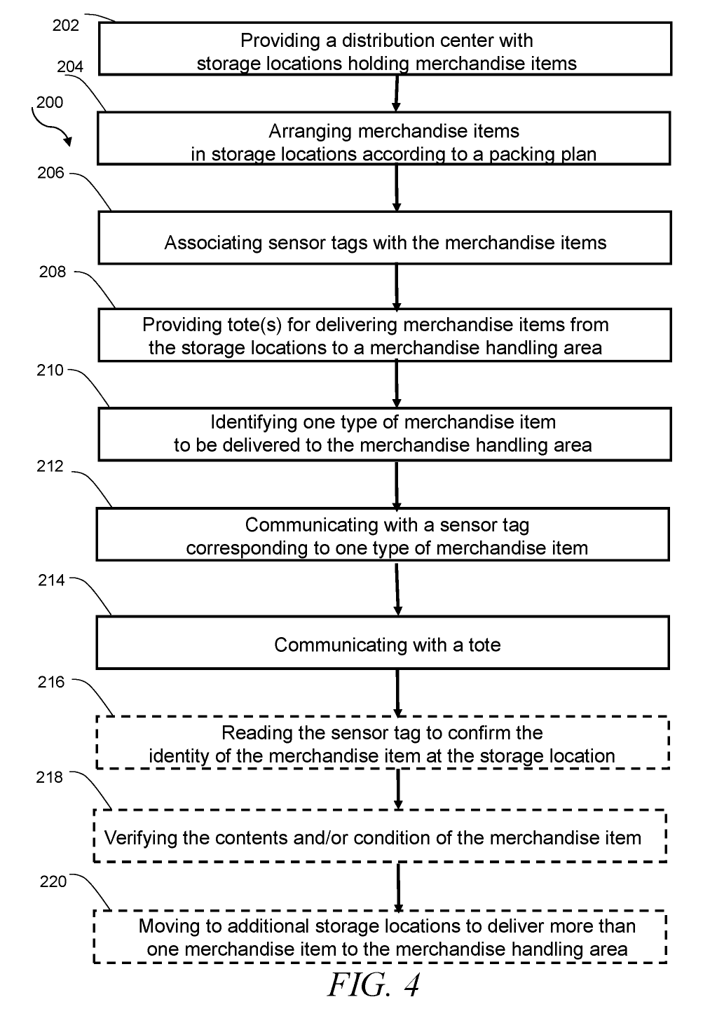

Referring to FIG. 4, there is shown a process 200 for storing and retrieving merchandise items in distribution centers. It is generally contemplated that the process 200 may use some or all of the components described above with respect to system 100. The process 200 generally uses totes to transport merchandise items arranged according to a packing plan to a merchandise handling area in the distribution center. It is generally contemplated that the process 200 may be employed in the context of dense storage of merchandise items.

At block 202, a distribution center is provided with storage locations holding merchandise items. In one form, the distribution center may be one of several distribution centers operated by a single retailer and used to hold merchandise to be transported to the retailer's stores for sale to customers. Alternatively, or in addition, the merchandise at the distribution center may be delivered directly to customers, such as via e-commerce, by the retailer's delivery vehicles or by third party delivery vehicles.

At block 204, the merchandise items in the storage locations of the distribution center may be arranged according to a packing plan. Different distribution centers operated by a retailer may be arranged according to different packing plans. The packing plans may be determined based on various factors (alone or in combination), such as merchandise item type, customer information, delivery distance, projected storage time, delivery time, and weather. In one form, the storage locations may be arranged across multiple dense storage units having multiple compartments (constituting the storage locations) with each compartment/storage location having unique coordinates to identify the location of the compartment/storage location.

At block 206, sensor tags are associated with the merchandise items. This associate may be performed in a variety of ways. For example, one sensor tag may be disposed at each individual storage location/department, or one sensor may be disposed at each dense storage unit that may correspond to a specific type of merchandise. Alternatively, or in addition, sensor tags may be disposed on the merchandise items themselves. Further, it is generally contemplated that the sensor tags are associated and arranged in accordance with the packing plan for the distribution center. In addition, it is contemplated that the sensor tags may be of various types, such as barcodes and RFID tags.

At block 208, totes are provided for delivering merchandise items from the storage locations to a merchandise handling area. In one form, it is contemplated that the totes are “smart” totes each with a control circuit allowing for the local distribution of intelligence and data. Further, it is generally contemplated that the totes may have a desired degree of independent operation, as desired. For example, the local control circuits may be configured to determine the storage locations of merchandise to be retrieved and/or to calculate routes to the storage locations and merchandise handling area.

At block 210, one type of merchandise item is identified for delivery to the merchandise handling area. For example, a user may select a merchandise item to be retrieved, and a general control circuit may identify the type of merchandise item. In one form, it is contemplated that the general control circuit may determine the product identifier for the type of merchandise item. In another form, this identification step may involve identifying the storage location(s) corresponding to the selected merchandise items according to the packing plan.

At block 212, there is a communication with a sensor tag to identify the storage location of the type of merchandise item. For example, the general control circuit may communicate with the sensor tags associated with the type of merchandise item in accordance with the packing plan. The general control circuit may communicate with the sensor tag(s) to confirm and verify that the merchandise is in the assigned storage location(s) according to the packing plan.

At block 214, there is communication with a tote. The general control circuit communicates with the tote to move it to the storage location to receive the merchandise item and to move it to the merchandise handling area. In one form, it is contemplated that the general control circuit need only provide general instructions, such as identifying one or merchandise items to be retrieved, and the “smart” tote may then determine the implementation of the general instructions. In this form, a local control circuit associated with the tote may navigate and calculate routes to different storage locations and to the merchandise storage location. The local control circuit may determine storage locations via a database, which may be in the form of a local database (at the tote) associating merchandise items with assigned storage locations or by wireless communication with a remote database containing this information. In another form, it is contemplated that the general control circuit may provide more detailed instructions and navigational guidance to the tote to move it to the storage locations and the merchandise handling area.

At block 216, when the tote arrives at the storage location, a sensor tag may be read/scanned to confirm the identity of the merchandise item at the storage location. In one form, this read/scanned information may be transmitted to the general control circuit to verify that the type of merchandise item is in the corresponding storage location according to the packing plan. The general control circuit may confirm the merchandise by comparing an identifier (such as a barcode or an RFID tag) for a merchandise item received at a storage location with an identifier retrieved from a product identifier database. In yet another form, this confirmation step may be performed by a local control circuit at the tote via a local database or via wireless communication with a remote database.

At block 218, the contents and/or condition of the merchandise item at the storage location may be verified. In one form, it is contemplated that this verification may be performed by an image capture device, such as any of various types of cameras or video devices. In one form, images captured by such devices can be compared to database images of merchandise items. For example, if the captured images show an insufficient quantity of merchandise, an incorrect type of merchandise item, or damage to the merchandise item, the captured image may not match the database images. Corrective action may then be taken, including removing the defective merchandise item and replacing it with a satisfactory merchandise item.

At block 220, the tote may move to additional storage locations to retrieve additional merchandise items prior to moving to the merchandise handling area. In other words, in one form, it is contemplated that the tote may retrieve more than one merchandise item during one trip. In moving from one storage location to the next storage location, some of the steps 210-218 may be repeated.

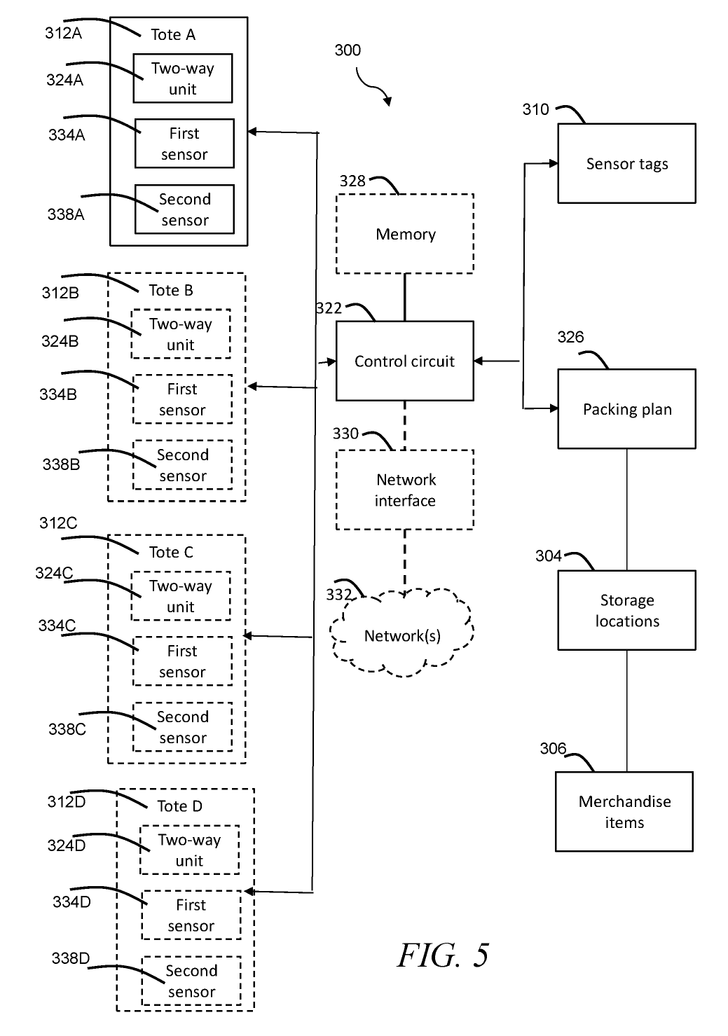

FIG. 5 shows another example of a system 300 for storing and retrieving merchandise items in distribution centers. The system 300 generally includes many of the same components shown in FIGS. 1 and 2. It is generally contemplated that totes will retrieve merchandise items from storage locations in dense storage units and will deliver them to a merchandise handling area. However, as addressed further below, it is generally contemplated that these totes are relatively “dumb” totes each having a two-way wireless communication component.

As shown in FIG. 5, merchandise items 306 are stored in storage locations 304 according to a desired packing plan 326. Sensor tags 310 are disposed about the distribution center and are associated with the merchandise items in some manner. Further, the system 300 includes a control circuit 322 that controls the overall operation of the system 300, and the control circuit 322 may be coupled to a memory 328, a network interface 330, and a network 332. These components operate in the same general manner as described above with respect to system 100 and process 200, and this description is incorporated by reference in this description of system 300.

The system 300 also includes tote(s), and in this example, the system 300 is shown with four totes 312A-D. It is generally contemplated that each tote 312A-D includes a two-way wireless communication component 324A-D that is communicatively coupled to the control circuit 322. Further, it is generally contemplated that the control circuit 322 will generally control much of the operation and navigation of each tote 312A-D through each two-way wireless communication component 324A-D. As addressed further below, in one form, it is contemplated that navigation through the distribution center may be on planned automated routes along conveyor assemblies (or rails, tracks, or other types of controlled navigation to storage locations and a merchandise handling area).

In one form, the control circuit 322 transmits to the two-way wireless communications component 324A-D information regarding at least a planned automated route through the distribution center. By one approach, the information transmitted to the two-way wireless communications component 324A-D constitutes or otherwise represents a planned automated route through the distribution center. Such a route can represent a complete route through the distribution center or only a portion of that route. Such information can identify, for example, one or more conveyor lines by which the tote 312A-D can be moved from one location to another within the distribution center. As a related example, such information can identify a particular conveyor path to be selected by an automated conveyor gate (the latter being a well-known conveyor system component in the prior art). As yet a further example, the foregoing information can include one or more codes or other authorizing instruments or information that can be provided (in response, for example, to a query to the two-way wireless communications component 324A-D) to system elements, such as an automated conveyor gate, to cause the latter to pass the tote 312A-D past the gate or to otherwise control movement of the tote 312A-D via a conveyor belt or belts in the distribution center.

Other possibilities, of course, exist in these regards. For example, the aforementioned route information can represent, directly or indirectly, distribution center floors and/or partitioned areas, aisles, columns, shelves, grid coordinates or other indicia of location, elevators, loading docks, doorways, and so forth as desired.

Accordingly, each tote 312A-D may include a two-way wireless communications component 324A-D that is attached to the tote 312A-D and configured to receive information regarding a planned automated route for the tote 312A-D to a storage location. In addition, the two-way wireless communications component 324A-D may be configured to receive information regarding the type of merchandise item 306 planned to be placed in the tote 312A-D at a storage location 304. After retrieving the merchandise item at the storage location 304, the control circuit 322 may transmit, and the two-way wireless communications component 324A-D may be configured to receive, information regarding additional planned automated route(s) for the tote 312A-D to other storage locations 304 to retrieve other merchandise items 306 or to a merchandise handling area.

The totes 312A-D may also include various types of sensor(s). For example, the tote 312A-D may include a sensor 334A-D to verify the contents or condition of the merchandise item 306 planned to be placed in the tote 312A-D. In one form, the sensor 334A-D may be in the form of an optical imaging device (e.g., camera or video apparatus) to capture images of the merchandise item 306. As another example, the tote 312A-D may include (alternatively or in addition) a sensor 338A-D for reading a sensor tag 310 to determine the identity of the type of merchandise item 306 at a storage location 304. In one form, the sensor 338A-D may be in the form of a barcode or RFID reader for reading barcode or RFID sensor tags 310. The two-way wireless communications component 324A-D may be configured to transmit the read information to the control circuit 322 to verify that the type of merchandise item 306 at the storage location 304 is correct and in accordance with the packing plan 326. The totes 312A-D may include additional sensors, such as obstacle sensors.

As addressed above, with respect to systems 100 and 300 and process 200, the merchandise items are stored according to a packing plan. Pursuant to this packing plan, the storage locations in the distribution center may be assigned and arranged, at least in part, based on factors such as merchandise item type, customer information, delivery distance, projected storage time, delivery time, and weather. As a first example, the storage locations may be arranged, at least in part, by merchandise item type. Each dense storage unit may be directed to a particular type of merchandise, such as, for example, the examples given with respect to system 100: refrigerated produce (108A), frozen grocery (108B), apparel (108C), sporting goods (108D), electronic devices (108E), and outdoor/yard/gardening goods (108F).

As a second example, the storage locations may be arranged, at least in part, by delivery distance and/or delivery time. In this example, each dense storage unit may include merchandise that is to be delivered within a certain delivery distance and/or delivery time, such as 0-5 miles, 6-10 miles, 10-15 miles, 16-20 miles, etc. In this example, it may be convenient to retrieve merchandise items from one dense storage unit that will be loaded onto a delivery vehicle that is intended to make deliveries to stores or other destinations within a certain distance or time from the distribution center. Further, this approach might be useful for refrigerated or frozen merchandise that may need to be maintained at certain temperatures during delivery. By storing refrigerated produce in one refrigerated dense storage unit corresponding to a certain delivery distance, it may be possible to maintain the temperature on the delivery vehicle for this time/distance.

As a third example, the storage locations may be arranged, at least in part, by projected storage time. This approach may be useful for merchandise with a limited shelf life. For example, refrigerated and/or frozen merchandise may be stored in dense storage units based on: 0-1 month shelf life, 1-2 months shelf life, etc. It may be desirable to retrieve such merchandise from dense storage units on a rotating basis such that merchandise with the shortest remaining shelf life is retrieved first so as to optimize turnover. Under another approach, it may be desirable to assign popular merchandise types that are frequently loaded onto delivery vehicles to dense storage units that are relatively close to the merchandise handling area.

As a fourth example, the storage locations may be arranged, at least in part, by weather and/or seasonality. For example, summer items (such as swimwear, beach items, shorts, etc.) may be stored in certain dense storage units. Further, winter items (such as coats, boots, skis, etc.) may be stored in other dense storage units.

As a fifth example, the storage locations may be arranged, at least in part, by customer information. In this regard, in one form, it is contemplated that merchandise may be stored in a manner corresponding to customer preferences and values. In one form, products may be arranged in dense storage units and storage locations according to “value vectors” assigned to those products. In another form, where customer information is available, products may be arranged by customer according to “value vectors” created for those customers based on known customer information. In yet another form, the packing plan may focus on a specific geographic region for each storage unit (or group of storage locations) and apply customer value vectors based on known demographic information to determine popular corresponding products for that region. The concept of “value vectors” is discussed as follows.

Generally speaking, many of these embodiments provide for a memory having information stored therein that includes partiality information for each of a plurality of persons in the form of a plurality of partiality vectors for each of the persons wherein each partiality vector has at least one of a magnitude and an angle that corresponds to a magnitude of the person's belief in an amount of good that comes from an order associated with that partiality. This memory can also contain vectorized characterizations for each of a plurality of products, wherein each of the vectorized characterizations includes a measure regarding an extent to which a corresponding one of the products accords with a corresponding one of the plurality of partiality vectors.

Rules can then be provided that use the aforementioned information in support of a wide variety of activities and results. Although the described vector-based approaches bear little resemblance (if any) (conceptually or in practice) to prior approaches to understanding and/or metricizing a given person's product/service requirements, these approaches yield numerous benefits including, at least in some cases, reduced memory requirements, an ability to accommodate (both initially and dynamically over time) an essentially endless number and variety of partialities and/or product attributes, and processing/comparison capabilities that greatly ease computational resource requirements and/or greatly reduced time-to-solution results.

So configured, these teachings can constitute, for example, a method for automatically correlating a particular product with a particular person by using a control circuit to obtain a set of rules that define the particular product from amongst a plurality of candidate products for the particular person as a function of vectorized representations of partialities for the particular person and vectorized characterizations for the candidate products. This control circuit can also obtain partiality information for the particular person in the form of a plurality of partiality vectors that each have at least one of a magnitude and an angle that corresponds to a magnitude of the particular person's belief in an amount of good that comes from an order associated with that partiality and vectorized characterizations for each of the candidate products, wherein each of the vectorized characterizations indicates a measure regarding an extent to which a corresponding one of the candidate products accords with a corresponding one of the plurality of partiality vectors. The control circuit can then generate an output comprising identification of the particular product by evaluating the partiality vectors and the vectorized characterizations against the set of rules.

The aforementioned set of rules can include, for example, comparing at least some of the partiality vectors for the particular person to each of the vectorized characterizations for each of the candidate products using vector dot product calculations. By another approach, in lieu of the foregoing or in combination therewith, the aforementioned set of rules can include using the partiality vectors and the vectorized characterizations to define a plurality of solutions that collectively form a multi-dimensional surface and selecting the particular product from the multi-dimensional surface. In such a case the set of rules can further include accessing other information (such as objective information) for the particular person comprising information other than partiality vectors and using the other information to constrain a selection area on the multi-dimensional surface from which the particular product can be selected.

People tend to be partial to ordering various aspects of their lives, which is to say, people are partial to having things well arranged per their own personal view of how things should be. As a result, anything that contributes to the proper ordering of things regarding which a person has partialities represents value to that person. Quite literally, improving order reduces entropy for the corresponding person (i.e., a reduction in the measure of disorder present in that particular aspect of that person's life) and that improvement in order/reduction in disorder is typically viewed with favor by the affected person.

Generally speaking a value proposition must be coherent (logically sound) and have “force.” Here, force takes the form of an imperative. When the parties to the imperative have a reputation of being trustworthy and the value proposition is perceived to yield a good outcome, then the imperative becomes anchored in the center of a belief that “this is something that I must do because the results will be good for me.” With the imperative so anchored, the corresponding material space can be viewed as conforming to the order specified in the proposition that will result in the good outcome.

Pursuant to these teachings a belief in the good that comes from imposing a certain order takes the form of a value proposition. It is a set of coherent logical propositions by a trusted source that, when taken together, coalesce to form an imperative that a person has a personal obligation to order their lives because it will return a good outcome which improves their quality of life. This imperative is a value force that exerts the physical force (effort) to impose the desired order. The inertial effects come from the strength of the belief. The strength of the belief comes from the force of the value argument (proposition). And the force of the value proposition is a function of the perceived good and trust in the source that convinced the person's belief system to order material space accordingly. A belief remains constant until acted upon by a new force of a trusted value argument. This is at least a significant reason why the routine in people's lives remains relatively constant.

Newton's three laws of motion have a very strong bearing on the present teachings. Stated summarily, Newton's first law holds that an object either remains at rest or continues to move at a constant velocity unless acted upon by a force, the second law holds that the vector sum of the forces F on an object equal the mass m of that object multiplied by the acceleration a of the object (i.e., F=ma), and the third law holds that when one body exerts a force on a second body, the second body simultaneously exerts a force equal in magnitude and opposite in direction on the first body.

Relevant to both the present teachings and Newton's first law, beliefs can be viewed as having inertia. In particular, once a person believes that a particular order is good, they tend to persist in maintaining that belief and resist moving away from that belief. The stronger that belief the more force an argument and/or fact will need to move that person away from that belief to a new belief.

Relevant to both the present teachings and Newton's second law, the “force” of a coherent argument can be viewed as equaling the “mass” which is the perceived Newtonian effort to impose the order that achieves the aforementioned belief in the good which an imposed order brings multiplied by the change in the belief of the good which comes from the imposition of that order. Consider that when a change in the value of a particular order is observed then there must have been a compelling value claim influencing that change. There is a proportionality in that the greater the change the stronger the value argument. If a person values a particular activity and is very diligent to do that activity even when facing great opposition, we say they are dedicated, passionate, and so forth. If they stop doing the activity, it begs the question, what made them stop? The answer to that question needs to carry enough force to account for the change.

And relevant to both the present teachings and Newton's third law, for every effort to impose good order there is an equal and opposite good reaction.

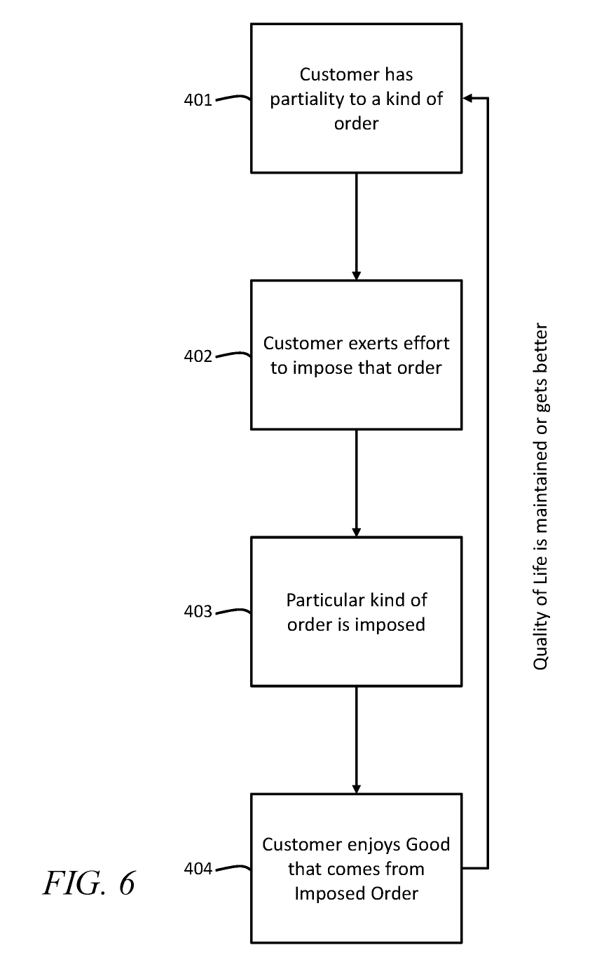

FIG. 6 provides a simple illustrative example in these regards. At block 401 it is understood that a particular person has a partiality (to a greater or lesser extent) to a particular kind of order. At block 402 that person willingly exerts effort to impose that order to thereby, at block 403, achieve an arrangement to which they are partial. And at block 404, this person appreciates the “good” that comes from successfully imposing the order to which they are partial, in effect establishing a positive feedback loop.

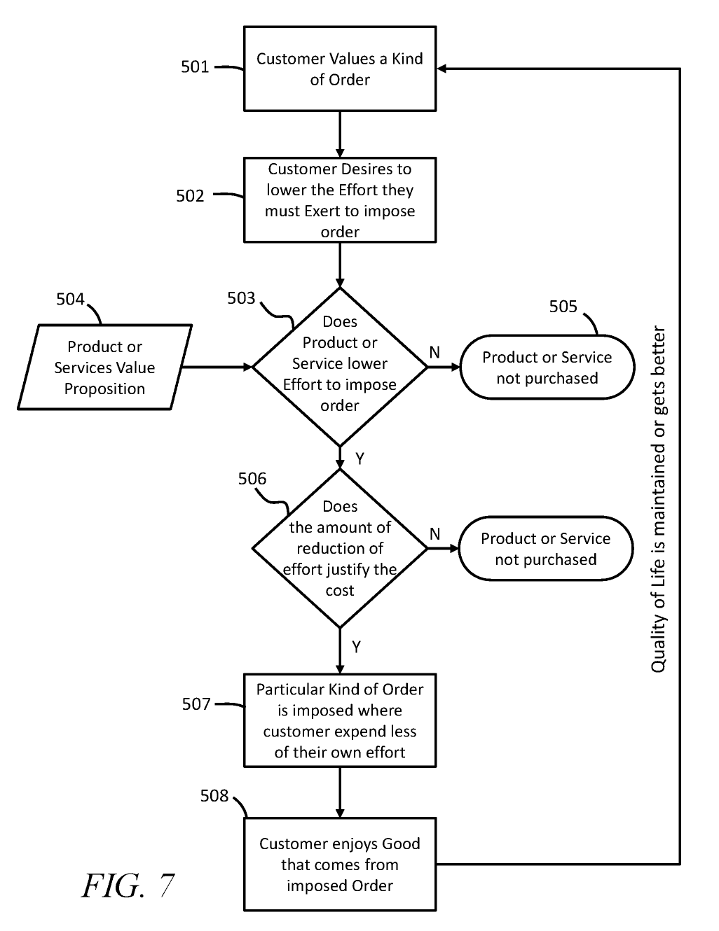

Understanding these partialities to particular kinds of order can be helpful to understanding how receptive a particular person may be to purchasing a given product or service. FIG. 7 provides a simple illustrative example in these regards. At block 501 it is understood that a particular person values a particular kind of order. At block 502 it is understood (or at least presumed) that this person wishes to lower the effort (or is at least receptive to lowering the effort) that they must personally exert to impose that order. At decision block 503 (and with access to information 504 regarding relevant products and or services) a determination can be made whether a particular product or service lowers the effort required by this person to impose the desired order. When such is not the case, it can be concluded that the person will not likely purchase such a product/service 505 (presuming better choices are available).

When the product or service does lower the effort required to impose the desired order, however, at block 506 a determination can be made as to whether the amount of the reduction of effort justifies the cost of purchasing and/or using the proffered product/service. If the cost does not justify the reduction of effort, it can again be concluded that the person will not likely purchase such a product/service 505. When the reduction of effort does justify the cost, however, this person may be presumed to want to purchase the product/service and thereby achieve the desired order (or at least an improvement with respect to that order) with less expenditure of their own personal effort (block 507) and thereby achieve, at block 508, corresponding enjoyment or appreciation of that result.

To facilitate such an analysis, the applicant has determined that factors pertaining to a person's partialities can be quantified and otherwise represented as corresponding vectors (where “vector” will be understood to refer to a geometric object/quantity having both an angle and a length/magnitude). These teachings will accommodate a variety of differing bases for such partialities including, for example, a person's values, affinities, aspirations, and preferences.

A value is a person's principle or standard of behavior, their judgment of what is important in life. A person's values represent their ethics, moral code, or morals and not a mere unprincipled liking or disliking of something. A person's value might be a belief in kind treatment of animals, a belief in cleanliness, a belief in the importance of personal care, and so forth.

An affinity is an attraction (or even a feeling of kinship) to a particular thing or activity. Examples including such a feeling towards a participatory sport such as golf or a spectator sport (including perhaps especially a particular team such as a particular professional or college football team), a hobby (such as quilting, model railroading, and so forth), one or more components of popular culture (such as a particular movie or television series, a genre of music or a particular musical performance group, or a given celebrity, for example), and so forth.

“Aspirations” refer to longer-range goals that require months or even years to reasonably achieve. As used herein “aspirations” does not include mere short term goals (such as making a particular meal tonight or driving to the store and back without a vehicular incident). The aspired-to goals, in turn, are goals pertaining to a marked elevation in one's core competencies (such as an aspiration to master a particular game such as chess, to achieve a particular articulated and recognized level of martial arts proficiency, or to attain a particular articulated and recognized level of cooking proficiency), professional status (such as an aspiration to receive a particular advanced education degree, to pass a professional examination such as a state Bar examination of a Certified Public Accountants examination, or to become Board certified in a particular area of medical practice), or life experience milestone (such as an aspiration to climb Mount Everest, to visit every state capital, or to attend a game at every major league baseball park in the United States). It will further be understood that the goal(s) of an aspiration is not something that can likely merely simply happen of its own accord; achieving an aspiration requires an intelligent effort to order one's life in a way that increases the likelihood of actually achieving the corresponding goal or goals to which that person aspires. One aspires to one day run their own business as versus, for example, merely hoping to one day win the state lottery.

A preference is a greater liking for one alternative over another or others. A person can prefer, for example, that their steak is cooked “medium” rather than other alternatives such as “rare” or “well done” or a person can prefer to play golf in the morning rather than in the afternoon or evening. Preferences can and do come into play when a given person makes purchasing decisions at a retail shopping facility. Preferences in these regards can take the form of a preference for a particular brand over other available brands or a preference for economy-sized packaging as versus, say, individual serving-sized packaging.

Values, affinities, aspirations, and preferences are not necessarily wholly unrelated. It is possible for a person's values, affinities, or aspirations to influence or even dictate their preferences in specific regards. For example, a person's moral code that values non-exploitive treatment of animals may lead them to prefer foods that include no animal-based ingredients and hence to prefer fruits and vegetables over beef and chicken offerings. As another example, a person's affinity for a particular musical group may lead them to prefer clothing that directly or indirectly references or otherwise represents their affinity for that group. As yet another example, a person's aspirations to become a Certified Public Accountant may lead them to prefer business-related media content.

While a value, affinity, or aspiration may give rise to or otherwise influence one or more corresponding preferences, however, is not to say that these things are all one and the same; they are not. For example, a preference may represent either a principled or an unprincipled liking for one thing over another, while a value is the principle itself. Accordingly, as used herein it will be understood that a partiality can include, in context, any one or more of a value-based, affinity-based, aspiration-based, and/or preference-based partiality unless one or more such features is specifically excluded per the needs of a given application setting.

Information regarding a given person's partialities can be acquired using any one or more of a variety of information-gathering and/or analytical approaches. By one simple approach, a person may voluntarily disclose information regarding their partialities (for example, in response to an online questionnaire or survey or as part of their social media presence). By another approach, the purchasing history for a given person can be analyzed to intuit the partialities that led to at least some of those purchases. By yet another approach demographic information regarding a particular person can serve as yet another source that sheds light on their partialities. Other ways that people reveal how they order their lives include but are not limited to: (1) their social networking profiles and behaviors (such as the things they “like” via Facebook, the images they post via Pinterest, informal and formal comments they initiate or otherwise provide in response to third-party postings including statements regarding their own personal long-term goals, the persons/topics they follow via Twitter, the photographs they publish via Picasso, and so forth); (2) their Internet surfing history; (3) their on-line or otherwise-published affinity-based memberships; (4) real-time (or delayed) information (such as steps walked, calories burned, geographic location, activities experienced, and so forth) from any of a variety of personal sensors (such as smart phones, tablet/pad-styled computers, fitness wearables, Global Positioning System devices, and so forth) and the so-called Internet of Things (such as smart refrigerators and pantries, entertainment and information platforms, exercise and sporting equipment, and so forth); (5) instructions, selections, and other inputs (including inputs that occur within augmented-reality user environments) made by a person via any of a variety of interactive interfaces (such as keyboards and cursor control devices, voice recognition, gesture-based controls, and eye tracking-based controls), and so forth.

The present teachings employ a vector-based approach to facilitate characterizing, representing, understanding, and leveraging such partialities to thereby identify products (and/or services) that will, for a particular corresponding consumer, provide for an improved or at least a favorable corresponding ordering for that consumer. Vectors are directed quantities that each have both a magnitude and a direction. Per the applicant's approach these vectors have a real, as versus a metaphorical, meaning in the sense of Newtonian physics. Generally speaking, each vector represents order imposed upon material space-time by a particular partiality.

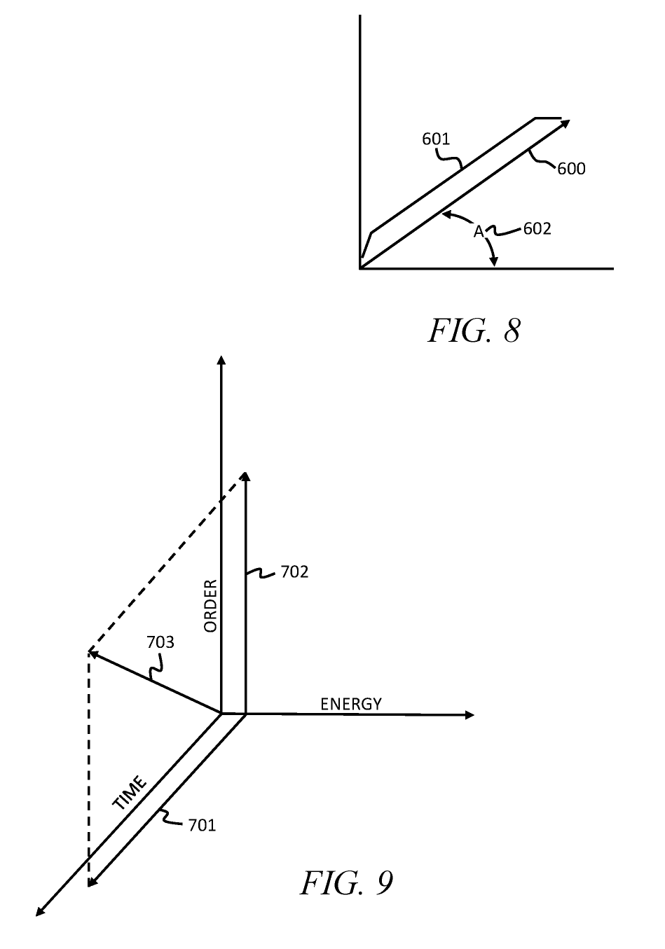

FIG. 8 provides some illustrative examples in these regards. By one approach the vector 600 has a corresponding magnitude 601 (i.e., length) that represents the magnitude of the strength of the belief in the good that comes from that imposed order (which belief, in turn, can be a function, relatively speaking, of the extent to which the order for this particular partiality is enabled and/or achieved). In this case, the greater the magnitude 601, the greater the strength of that belief and vice versa. Per another example, the vector 600 has a corresponding angle A 602 that instead represents the foregoing magnitude of the strength of the belief (and where, for example, an angle of 0° represents no such belief and an angle of 90° represents a highest magnitude in these regards, with other ranges being possible as desired).

Accordingly, a vector serving as a partiality vector can have at least one of a magnitude and an angle that corresponds to a magnitude of a particular person's belief in an amount of good that comes from an order associated with a particular partiality.

Applying force to displace an object with mass in the direction of a certain partiality-based order creates worth for a person who has that partiality. The resultant work (i.e., that force multiplied by the distance the object moves) can be viewed as a worth vector having a magnitude equal to the accomplished work and having a direction that represents the corresponding imposed order. If the resultant displacement results in more order of the kind that the person is partial to then the net result is a notion of “good.” This “good” is a real quantity that exists in meta-physical space much like work is a real quantity in material space. The link between the “good” in meta-physical space and the work in material space is that it takes work to impose order that has value.

In the context of a person, this effort can represent, quite literally, the effort that the person is willing to exert to be compliant with (or to otherwise serve) this particular partiality. For example, a person who values animal rights would have a large magnitude worth vector for this value if they exerted considerable physical effort towards this cause by, for example, volunteering at animal shelters or by attending protests of animal cruelty.

While these teachings will readily employ a direct measurement of effort such as work done or time spent, these teachings will also accommodate using an indirect measurement of effort such as expense; in particular, money. In many cases people trade their direct labor for payment. The labor may be manual or intellectual. While salaries and payments can vary significantly from one person to another, a same sense of effort applies at least in a relative sense.

As a very specific example in these regards, there are wristwatches that require a skilled craftsman over a year to make. The actual aggregated amount of force applied to displace the small components that comprise the wristwatch would be relatively very small. That said, the skilled craftsman acquired the necessary skill to so assemble the wristwatch over many years of applying force to displace thousands of little parts when assembly previous wristwatches. That experience, based upon a much larger aggregation of previously-exerted effort, represents a genuine part of the “effort” to make this particular wristwatch and hence is fairly considered as part of the wristwatch's worth.

The conventional forces working in each person's mind are typically more-or-less constantly evaluating the value propositions that correspond to a path of least effort to thereby order their lives towards the things they value. A key reason that happens is because the actual ordering occurs in material space and people must exert real energy in pursuit of their desired ordering. People therefore naturally try to find the path with the least real energy expended that still moves them to the valued order. Accordingly, a trusted value proposition that offers a reduction of real energy will be embraced as being “good” because people will tend to be partial to anything that lowers the real energy they are required to exert while remaining consistent with their partialities.

FIG. 9 presents a space graph that illustrates many of the foregoing points. A first vector 701 represents the time required to make such a wristwatch while a second vector 702 represents the order associated with such a device (in this case, that order essentially represents the skill of the craftsman). These two vectors 701 and 702 in turn sum to form a third vector 703 that constitutes a value vector for this wristwatch. This value vector 703, in turn, is offset with respect to energy (i.e., the energy associated with manufacturing the wristwatch).

A person partial to precision and/or to physically presenting an appearance of success and status (and who presumably has the wherewithal) may, in turn, be willing to spend $100,000 for such a wristwatch. A person able to afford such a price, of course, may themselves be skilled at imposing a certain kind of order that other persons are partial to such that the amount of physical work represented by each spent dollar is small relative to an amount of dollars they receive when exercising their skill(s). (Viewed another way, wearing an expensive wristwatch may lower the effort required for such a person to communicate that their own personal success comes from being highly skilled in a certain order of high worth.)

Generally speaking, all worth comes from imposing order on the material space-time. The worth of a particular order generally increases as the skill required to impose the order increases. Accordingly, unskilled labor may exchange $10 for every hour worked where the work has a high content of unskilled physical labor while a highly-skilled data scientist may exchange $75 for every hour worked with very little accompanying physical effort.

Consider a simple example where both of these laborers are partial to a well-ordered lawn and both have a corresponding partiality vector in those regards with a same magnitude. To observe that partiality the unskilled laborer may own an inexpensive push power lawn mower that this person utilizes for an hour to mow their lawn. The data scientist, on the other hand, pays someone else $75 in this example to mow their lawn. In both cases these two individuals traded one hour of worth creation to gain the same worth (to them) in the form of a well-ordered lawn; the unskilled laborer in the form of direct physical labor and the data scientist in the form of money that required one hour of their specialized effort to earn.

This same vector-based approach can also represent various products and services. This is because products and services have worth (or not) because they can remove effort (or fail to remove effort) out of the customer's life in the direction of the order to which the customer is partial. In particular, a product has a perceived effort embedded into each dollar of cost in the same way that the customer has an amount of perceived effort embedded into each dollar earned. A customer has an increased likelihood of responding to an exchange of value if the vectors for the product and the customer's partiality are directionally aligned and where the magnitude of the vector as represented in monetary cost is somewhat greater than the worth embedded in the customer's dollar.

Put simply, the magnitude (and/or angle) of a partiality vector for a person can represent, directly or indirectly, a corresponding effort the person is willing to exert to pursue that partiality. There are various ways by which that value can be determined. As but one non-limiting example in these regards, the magnitude/angle V of a particular partiality vector can be expressed as:

$$V = [ \begin{matrix}{X}_{1} \\ ⋮ \\ {X}_{n}\end{matrix} ] [ {W}_{1} … {W}_{n} ]$$

where X refers to any of a variety of inputs (such as those described above) that can impact the characterization of a particular partiality (and where these teachings will accommodate either or both subjective and objective inputs as desired) and W refers to weighting factors that are appropriately applied the foregoing input values (and where, for example, these weighting factors can have values that themselves reflect a particular person's consumer personality or otherwise as desired and can be static or dynamically valued in practice as desired).

In the context of a product (or service) the magnitude/angle of the corresponding vector can represent the reduction of effort that must be exerted when making use of this product to pursue that partiality, the effort that was expended in order to create the product/service, the effort that the person perceives can be personally saved while nevertheless promoting the desired order, and/or some other corresponding effort. Taken as a whole the sum of all the vectors must be perceived to increase the overall order to be considered a good product/service.

It may be noted that while reducing effort provides a very useful metric in these regards, it does not necessarily follow that a given person will always gravitate to that which most reduces effort in their life. This is at least because a given person's values (for example) will establish a baseline against which a person may eschew some goods/services that might in fact lead to a greater overall reduction of effort but which would conflict, perhaps fundamentally, with their values. As a simple illustrative example, a given person might value physical activity. Such a person could experience reduced effort (including effort represented via monetary costs) by simply sitting on their couch, but instead will pursue activities that involve that valued physical activity. That said, however, the goods and services that such a person might acquire in support of their physical activities are still likely to represent increased order in the form of reduced effort where that makes sense. For example, a person who favors rock climbing might also favor rock climbing clothing and supplies that render that activity safer to thereby reduce the effort required to prevent disorder as a consequence of a fall (and consequently increasing the good outcome of the rock climber's quality experience).

By forming reliable partiality vectors for various individuals and corresponding product characterization vectors for a variety of products and/or services, these teachings provide a useful and reliable way to identify products/services that accord with a given person's own partialities (whether those partialities are based on their values, their affinities, their preferences, or otherwise).

It is of course possible that partiality vectors may not be available yet for a given person due to a lack of sufficient specific source information from or regarding that person. In this case it may nevertheless be possible to use one or more partiality vector templates that generally represent certain groups of people that fairly include this particular person. For example, if the person's gender, age, academic status/achievements, and/or postal code are known it may be useful to utilize a template that includes one or more partiality vectors that represent some statistical average or norm of other persons matching those same characterizing parameters. (Of course, while it may be useful to at least begin to employ these teachings with certain individuals by using one or more such templates, these teachings will also accommodate modifying (perhaps significantly and perhaps quickly) such a starting point over time as part of developing a more personal set of partiality vectors that are specific to the individual.) A variety of templates could be developed based, for example, on professions, academic pursuits and achievements, nationalities and/or ethnicities, characterizing hobbies, and the like.

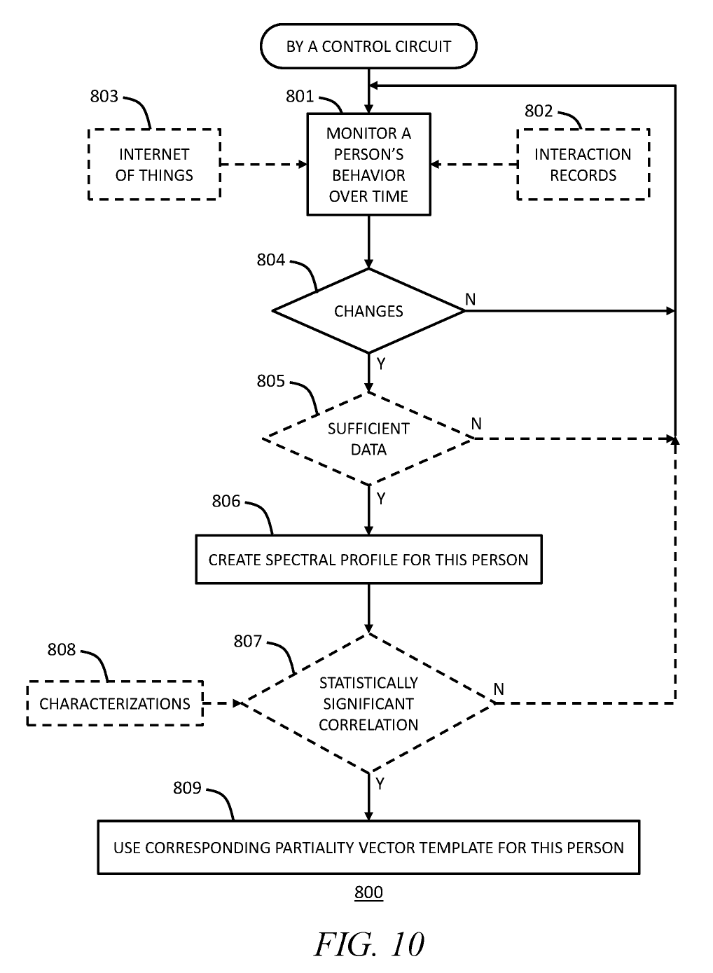

FIG. 10 presents a process 800 that illustrates yet another approach in these regards. For the sake of an illustrative example it will be presumed here that a control circuit of choice (with useful examples in these regards being presented further below) carries out one or more of the described steps/actions.

At block 801 the control circuit monitors a person's behavior over time. The range of monitored behaviors can vary with the individual and the application setting. By one approach, only behaviors that the person has specifically approved for monitoring are so monitored.

As one example in these regards, this monitoring can be based, in whole or in part, upon interaction records 802 that reflect or otherwise track, for example, the monitored person's purchases. This can include specific items purchased by the person, from whom the items were purchased, where the items were purchased, how the items were purchased (for example, at a bricks-and-mortar physical retail shopping facility or via an on-line shopping opportunity), the price paid for the items, and/or which items were returned and when), and so forth.

As another example in these regards the interaction records 802 can pertain to the social networking behaviors of the monitored person including such things as their “likes,” their posted comments, images, and tweets, affinity group affiliations, their on-line profiles, their playlists and other indicated “favorites,” and so forth. Such information can sometimes comprise a direct indication of a particular partiality or, in other cases, can indirectly point towards a particular partiality and/or indicate a relative strength of the person's partiality.

Other interaction records of potential interest include but are not limited to registered political affiliations and activities, credit reports, military-service history, educational and employment history, and so forth.

As another example, in lieu of the foregoing or in combination therewith, this monitoring can be based, in whole or in part, upon sensor inputs from the Internet of Things (IOT) 803. The Internet of Things refers to the Internet-based inter-working of a wide variety of physical devices including but not limited to wearable or carriable devices, vehicles, buildings, and other items that are embedded with electronics, software, sensors, network connectivity, and sometimes actuators that enable these objects to collect and exchange data via the Internet. In particular, the Internet of Things allows people and objects pertaining to people to be sensed and corresponding information to be transferred to remote locations via intervening network infrastructure. Some experts estimate that the Internet of Things will consist of almost 50 billion such objects by 2020. (Further description in these regards appears further herein.)

Depending upon what sensors a person encounters, information can be available regarding a person's travels, lifestyle, calorie expenditure over time, diet, habits, interests and affinities, choices and assumed risks, and so forth. This process 800 will accommodate either or both real-time or non-real time access to such information as well as either or both push and pull-based paradigms.

By monitoring a person's behavior over time a general sense of that person's daily routine can be established (sometimes referred to herein as a routine experiential base state). As a very simple illustrative example, a routine experiential base state can include a typical daily event timeline for the person that represents typical locations that the person visits and/or typical activities in which the person engages. The timeline can indicate those activities that tend to be scheduled (such as the person's time at their place of employment or their time spent at their child's sports practices) as well as visits/activities that are normal for the person though not necessarily undertaken with strict observance to a corresponding schedule (such as visits to local stores, movie theaters, and the homes of nearby friends and relatives).

At block 804 this process 800 provides for detecting changes to that established routine. These teachings are highly flexible in these regards and will accommodate a wide variety of “changes.” Some illustrative examples include but are not limited to changes with respect to a person's travel schedule, destinations visited or time spent at a particular destination, the purchase and/or use of new and/or different products or services, a subscription to a new magazine, a new Rich Site Summary (RSS) feed or a subscription to a new blog, a new “friend” or “connection” on a social networking site, a new person, entity, or cause to follow on a Twitter-like social networking service, enrollment in an academic program, and so forth.

Upon detecting a change, at optional block 805 this process 800 will accommodate assessing whether the detected change constitutes a sufficient amount of data to warrant proceeding further with the process. This assessment can comprise, for example, assessing whether a sufficient number (i.e., a predetermined number) of instances of this particular detected change have occurred over some predetermined period of time. As another example, this assessment can comprise assessing whether the specific details of the detected change are sufficient in quantity and/or quality to warrant further processing. For example, merely detecting that the person has not arrived at their usual 6 PM-Wednesday dance class may not be enough information, in and of itself, to warrant further processing, in which case the information regarding the detected change may be discarded or, in the alternative, cached for further consideration and use in conjunction or aggregation with other, later-detected changes.

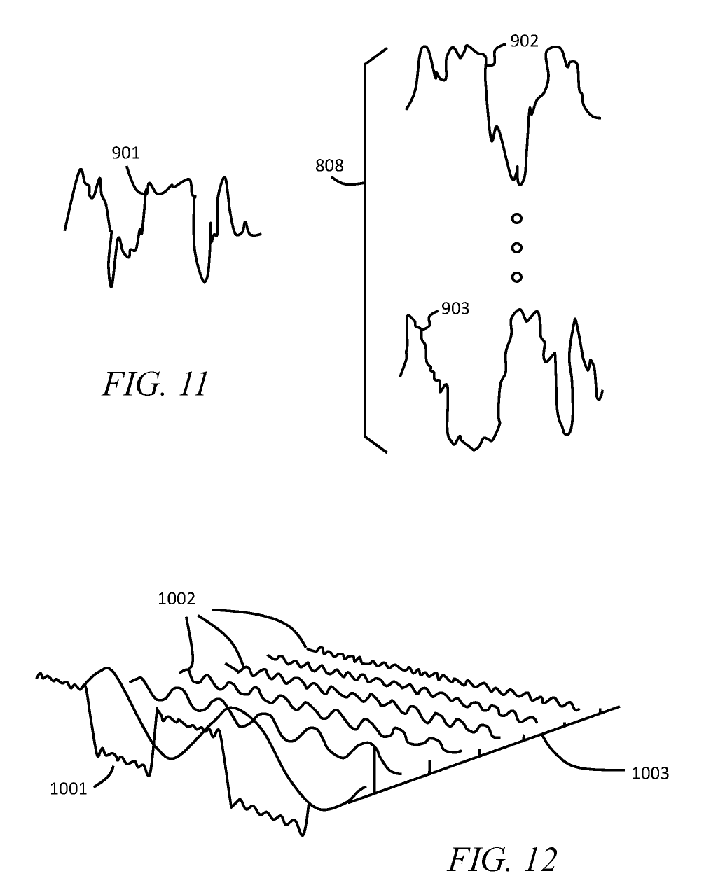

At block 807 this process 800 uses these detected changes to create a spectral profile for the monitored person. FIG. 11 provides an illustrative example in these regards with the spectral profile denoted by reference numeral 901. In this illustrative example the spectral profile 901 represents changes to the person's behavior over a given period of time (such as an hour, a day, a week, or some other temporal window of choice). Such a spectral profile can be as multidimensional as may suit the needs of a given application setting.

At optional block 807 this process 800 then provides for determining whether there is a statistically significant correlation between the aforementioned spectral profile and any of a plurality of like characterizations 808. The like characterizations 808 can comprise, for example, spectral profiles that represent an average of groupings of people who share many of the same (or all of the same) identified partialities. As a very simple illustrative example in these regards, a first such characterization 902 might represent a composite view of a first group of people who have three similar partialities but a dissimilar fourth partiality while another of the characterizations 903 might represent a composite view of a different group of people who share all four partialities.

The aforementioned “statistically significant” standard can be selected and/or adjusted to suit the needs of a given application setting. The scale or units by which this measurement can be assessed can be any known, relevant scale/unit including, but not limited to, scales such as standard deviations, cumulative percentages, percentile equivalents, Z-scores, T-scores, standard nines, and percentages in standard nines. Similarly, the threshold by which the level of statistical significance is measured/assessed can be set and selected as desired. By one approach the threshold is static such that the same threshold is employed regardless of the circumstances. By another approach the threshold is dynamic and can vary with such things as the relative size of the population of people upon which each of the characterizations 508 are based and/or the amount of data and/or the duration of time over which data is available for the monitored person.

Referring now to FIG. 12, by one approach the selected characterization (denoted by reference numeral 1001 in this figure) comprises an activity profile over time of one or more human behaviors. Examples of behaviors include but are not limited to such things as repeated purchases over time of particular commodities, repeated visits over time to particular locales such as certain restaurants, retail outlets, athletic or entertainment facilities, and so forth, and repeated activities over time such as floor cleaning, dish washing, car cleaning, cooking, volunteering, and so forth. Those skilled in the art will understand and appreciate, however, that the selected characterization is not, in and of itself, demographic data (as described elsewhere herein).

More particularly, the characterization 1001 can represent (in this example, for a plurality of different behaviors) each instance over the monitored/sampled period of time when the monitored/represented person engages in a particular represented behavior (such as visiting a neighborhood gym, purchasing a particular product (such as a consumable perishable or a cleaning product), interacts with a particular affinity group via social networking, and so forth). The relevant overall time frame can be chosen as desired and can range in a typical application setting from a few hours or one day to many days, weeks, or even months or years. (It will be understood by those skilled in the art that the particular characterization shown in FIG. 12 is intended to serve an illustrative purpose and does not necessarily represent or mimic any particular behavior or set of behaviors).

Generally speaking it is anticipated that many behaviors of interest will occur at regular or somewhat regular intervals and hence will have a corresponding frequency or periodicity of occurrence. For some behaviors that frequency of occurrence may be relatively often (for example, oral hygiene events that occur at least once, and often multiple times each day) while other behaviors (such as the preparation of a holiday meal) may occur much less frequently (such as only once, or only a few times, each year). For at least some behaviors of interest that general (or specific) frequency of occurrence can serve as a significant indication of a person's corresponding partialities.

By one approach, these teachings will accommodate detecting and timestamping each and every event/activity/behavior or interest as it happens. Such an approach can be memory intensive and require considerable supporting infrastructure.

The present teachings will also accommodate, however, using any of a variety of sampling periods in these regards. In some cases, for example, the sampling period per se may be one week in duration. In that case, it may be sufficient to know that the monitored person engaged in a particular activity (such as cleaning their car) a certain number of times during that week without known precisely when, during that week, the activity occurred. In other cases it may be appropriate or even desirable, to provide greater granularity in these regards. For example, it may be better to know which days the person engaged in the particular activity or even the particular hour of the day. Depending upon the selected granularity/resolution, selecting an appropriate sampling window can help reduce data storage requirements (and/or corresponding analysis/processing overhead requirements).

Although a given person's behaviors may not, strictly speaking, be continuous waves (as shown in FIG. 12) in the same sense as, for example, a radio or acoustic wave, it will nevertheless be understood that such a behavioral characterization 1001 can itself be broken down into a plurality of sub-waves 1002 that, when summed together, equal or at least approximate to some satisfactory degree the behavioral characterization 1001 itself. (The more-discrete and sometimes less-rigidly periodic nature of the monitored behaviors may introduce a certain amount of error into the corresponding sub-waves. There are various mathematically satisfactory ways by which such error can be accommodated including by use of weighting factors and/or expressed tolerances that correspond to the resultant sub-waves.)

It should also be understood that each such sub-wave can often itself be associated with one or more corresponding discrete partialities. For example, a partiality reflecting concern for the environment may, in turn, influence many of the included behavioral events (whether they are similar or dissimilar behaviors or not) and accordingly may, as a sub-wave, comprise a relatively significant contributing factor to the overall set of behaviors as monitored over time. These sub-waves (partialities) can in turn be clearly revealed and presented by employing a transform (such as a Fourier transform) of choice to yield a spectral profile 1003 wherein the X axis represents frequency and the Y axis represents the magnitude of the response of the monitored person at each frequency/sub-wave of interest.

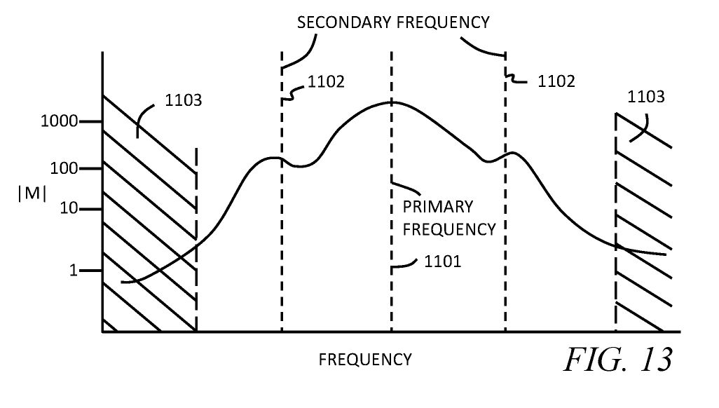

This spectral response of a given individual—which is generated from a time series of events that reflect/track that person's behavior—yields frequency response characteristics for that person that are analogous to the frequency response characteristics of physical systems such as, for example, an analog or digital filter or a second order electrical or mechanical system. Referring to FIG. 13, for many people the spectral profile of the individual person will exhibit a primary frequency 1101 for which the greatest response (perhaps many orders of magnitude greater than other evident frequencies) to life is exhibited and apparent. In addition, the spectral profile may also possibly identify one or more secondary frequencies 1102 above and/or below that primary frequency 1101. (It may be useful in many application settings to filter out more distant frequencies 1103 having considerably lower magnitudes because of a reduced likelihood of relevance and/or because of a possibility of error in those regards; in effect, these lower-magnitude signals constitute noise that such filtering can remove from consideration.)

As noted above, the present teachings will accommodate using sampling windows of varying size. By one approach the frequency of events that correspond to a particular partiality can serve as a basis for selecting a particular sampling rate to use when monitoring for such events. For example, Nyquist-based sampling rules (which dictate sampling at a rate at least twice that of the frequency of the signal of interest) can lead one to choose a particular sampling rate (and the resultant corresponding sampling window size).

As a simple illustration, if the activity of interest occurs only once a week, then using a sampling of half-a-week and sampling twice during the course of a given week will adequately capture the monitored event. If the monitored person's behavior should change, a corresponding change can be automatically made. For example, if the person in the foregoing example begins to engage in the specified activity three times a week, the sampling rate can be switched to six times per week (in conjunction with a sampling window that is resized accordingly).

By one approach, the sampling rate can be selected and used on a partiality-by-partiality basis. This approach can be especially useful when different monitoring modalities are employed to monitor events that correspond to different partialities. If desired, however, a single sampling rate can be employed and used for a plurality (or even all) partialities/behaviors. In that case, it can be useful to identify the behavior that is exemplified most often (i.e., that behavior which has the highest frequency) and then select a sampling rate that is at least twice that rate of behavioral realization, as that sampling rate will serve well and suffice for both that highest-frequency behavior and all lower-frequency behaviors as well.

It can be useful in many application settings to assume that the foregoing spectral profile of a given person is an inherent and inertial characteristic of that person and that this spectral profile, in essence, provides a personality profile of that person that reflects not only how but why this person responds to a variety of life experiences. More importantly, the partialities expressed by the spectral profile for a given person will tend to persist going forward and will not typically change significantly in the absence of some powerful external influence (including but not limited to significant life events such as, for example, marriage, children, loss of job, promotion, and so forth).

In any event, by knowing a priori the particular partialities (and corresponding strengths) that underlie the particular characterization 1001, those partialities can be used as an initial template for a person whose own behaviors permit the selection of that particular characterization 1001. In particular, those particularities can be used, at least initially, for a person for whom an amount of data is not otherwise available to construct a similarly rich set of partiality information.

As a very specific and non-limiting example, per these teachings the choice to make a particular product can include consideration of one or more value systems of potential customers. When considering persons who value animal rights, a product conceived to cater to that value proposition may require a corresponding exertion of additional effort to order material space-time such that the product is made in a way that (A) does not harm animals and/or (even better) (B) improves life for animals (for example, eggs obtained from free range chickens). The reason a person exerts effort to order material space-time is because they believe it is good to do and/or not good to not do so. When a person exerts effort to do good (per their personal standard of “good”) and if that person believes that a particular order in material space-time (that includes the purchase of a particular product) is good to achieve, then that person will also believe that it is good to buy as much of that particular product (in order to achieve that good order) as their finances and needs reasonably permit (all other things being equal).

The aforementioned additional effort to provide such a product can (typically) convert to a premium that adds to the price of that product. A customer who puts out extra effort in their life to value animal rights will typically be willing to pay that extra premium to cover that additional effort exerted by the company. By one approach a magnitude that corresponds to the additional effort exerted by the company can be added to the person's corresponding value vector because a product or service has worth to the extent that the product/service allows a person to order material space-time in accordance with their own personal value system while allowing that person to exert less of their own effort in direct support of that value (since money is a scalar form of effort).

By one approach there can be hundreds or even thousands of identified partialities. In this case, if desired, each product/service of interest can be assessed with respect to each and every one of these partialities and a corresponding partiality vector formed to thereby build a collection of partiality vectors that collectively characterize the product/service. As a very simple example in these regards, a given laundry detergent might have a cleanliness partiality vector with a relatively high magnitude (representing the effectiveness of the detergent), a ecology partiality vector that might be relatively low or possibly even having a negative magnitude (representing an ecologically disadvantageous effect of the detergent post usage due to increased disorder in the environment), and a simple-life partiality vector with only a modest magnitude (representing the relative ease of use of the detergent but also that the detergent presupposes that the user has a modern washing machine). Other partiality vectors for this detergent, representing such things as nutrition or mental acuity, might have magnitudes of zero.

As mentioned above, these teachings can accommodate partiality vectors having a negative magnitude. Consider, for example, a partiality vector representing a desire to order things to reduce one's so-called carbon footprint. A magnitude of zero for this vector would indicate a completely neutral effect with respect to carbon emissions while any positive-valued magnitudes would represent a net reduction in the amount of carbon in the atmosphere, hence increasing the ability of the environment to be ordered. Negative magnitudes would represent the introduction of carbon emissions that increases disorder of the environment (for example, as a result of manufacturing the product, transporting the product, and/or using the product)

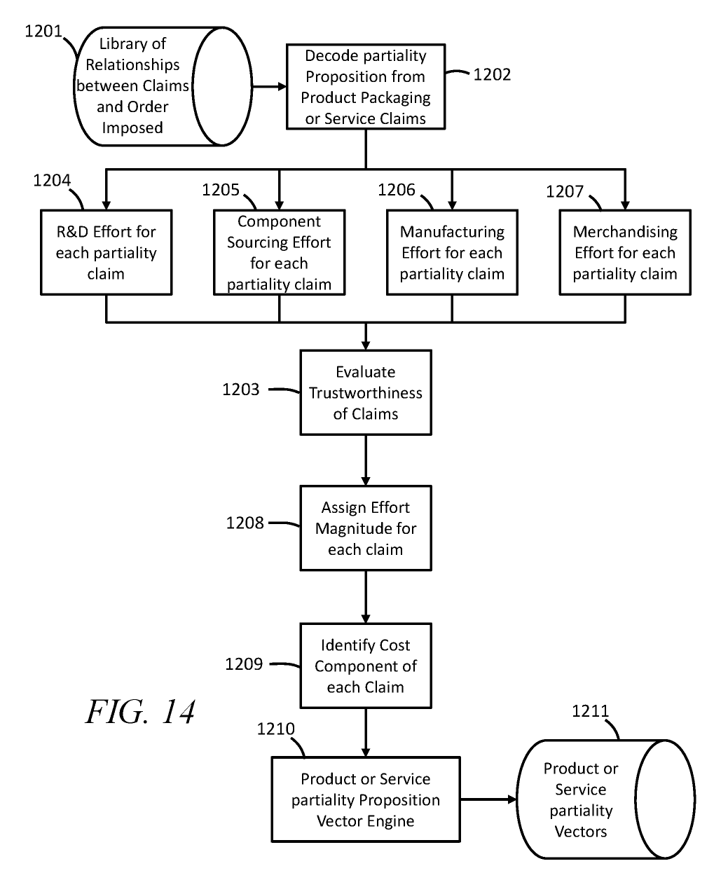

FIG. 14 presents one non-limiting illustrative example in these regards. The illustrated process presumes the availability of a library 1201 of correlated relationships between product/service claims and particular imposed orders. Examples of product/service claims include such things as claims that a particular product results in cleaner laundry or household surfaces, or that a particular product is made in a particular political region (such as a particular state or country), or that a particular product is better for the environment, and so forth. The imposed orders to which such claims are correlated can reflect orders as described above that pertain to corresponding partialities.

At block 1202 this process provides for decoding one or more partiality propositions from specific product packaging (or service claims). For example, the particular textual/graphics-based claims presented on the packaging of a given product can be used to access the aforementioned library 1201 to identify one or more corresponding imposed orders from which one or more corresponding partialities can then be identified.

At block 1203 this process provides for evaluating the trustworthiness of the aforementioned claims. This evaluation can be based upon any one or more of a variety of data points as desired. FIG. 14 illustrates four significant possibilities in these regards. For example, at block 1204 an actual or estimated research and development effort can be quantified for each claim pertaining to a partiality. At block 1205 an actual or estimated component sourcing effort for the product in question can be quantified for each claim pertaining to a partiality. At block 1206 an actual or estimated manufacturing effort for the product in question can be quantified for each claim pertaining to a partiality. And at block 1207 an actual or estimated merchandising effort for the product in question can be quantified for each claim pertaining to a partiality.

If desired, a product claim lacking sufficient trustworthiness may simply be excluded from further consideration. By another approach the product claim can remain in play but a lack of trustworthiness can be reflected, for example, in a corresponding partiality vector direction or magnitude for this particular product.

At block 1208 this process provides for assigning an effort magnitude for each evaluated product/service claim. That effort can constitute a one-dimensional effort (reflecting, for example, only the manufacturing effort) or can constitute a multidimensional effort that reflects, for example, various categories of effort such as the aforementioned research and development effort, component sourcing effort, manufacturing effort, and so forth.

At block 1209 this process provides for identifying a cost component of each claim, this cost component representing a monetary value. At block 1210 this process can use the foregoing information with a product/service partiality propositions vector engine to generate a library 1211 of one or more corresponding partiality vectors for the processed products/services. Such a library can then be used as described herein in conjunction with partiality vector information for various persons to identify, for example, products/services that are well aligned with the partialities of specific individuals.

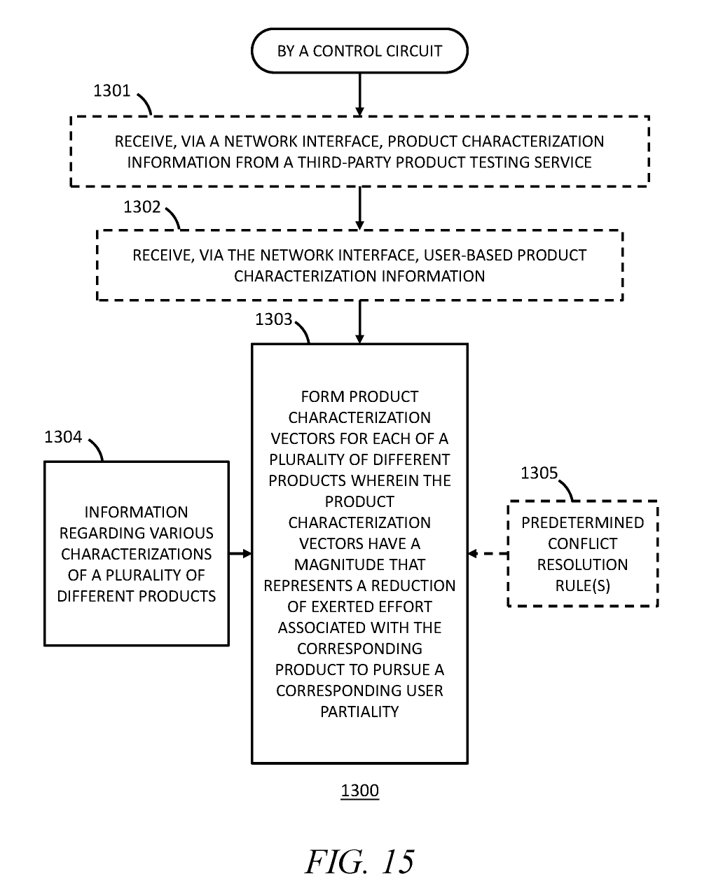

FIG. 15 provides another illustrative example in these same regards and may be employed in lieu of the foregoing or in total or partial combination therewith. Generally speaking, this process 1300 serves to facilitate the formation of product characterization vectors for each of a plurality of different products where the magnitude of the vector length (and/or the vector angle) has a magnitude that represents a reduction of exerted effort associated with the corresponding product to pursue a corresponding user partiality.

By one approach, and as illustrated in FIG. 15, this process 1300 can be carried out by a control circuit of choice. Specific examples of control circuits are provided elsewhere herein.

As described further herein in detail, this process 1300 makes use of information regarding various characterizations of a plurality of different products. These teachings are highly flexible in practice and will accommodate a wide variety of possible information sources and types of information. By one optional approach, and as shown at optional block 1301, the control circuit can receive (for example, via a corresponding network interface of choice) product characterization information from a third-party product testing service. The magazine/web resource Consumers Report provides one useful example in these regards. Such a resource provides objective content based upon testing, evaluation, and comparisons (and sometimes also provides subjective content regarding such things as aesthetics, ease of use, and so forth) and this content, provided as-is or pre-processed as desired, can readily serve as useful third-party product testing service product characterization information.

As another example, any of a variety of product-testing blogs that are published on the Internet can be similarly accessed and the product characterization information available at such resources harvested and received by the control circuit. (The expression “third party” will be understood to refer to an entity other than the entity that operates/controls the control circuit and other than the entity that provides the corresponding product itself.)

As another example, and as illustrated at optional block 1302, the control circuit can receive (again, for example, via a network interface of choice) user-based product characterization information. Examples in these regards include but are not limited to user reviews provided on-line at various retail sites for products offered for sale at such sites. The reviews can comprise metricized content (for example, a rating expressed as a certain number of stars out of a total available number of stars, such as 3 stars out of 5 possible stars) and/or text where the reviewers can enter their objective and subjective information regarding their observations and experiences with the reviewed products. In this case, “user-based” will be understood to refer to users who are not necessarily professional reviewers (though it is possible that content from such persons may be included with the information provided at such a resource) but who presumably purchased the product being reviewed and who have personal experience with that product that forms the basis of their review. By one approach the resource that offers such content may constitute a third party as defined above, but these teachings will also accommodate obtaining such content from a resource operated or sponsored by the enterprise that controls/operates this control circuit.

In any event, this process 1300 provides for accessing (see block 1304) information regarding various characterizations of each of a plurality of different products. This information 1304 can be gleaned as described above and/or can be obtained and/or developed using other resources as desired. As one illustrative example in these regards, the manufacturer and/or distributor of certain products may source useful content in these regards.

These teachings will accommodate a wide variety of information sources and types including both objective characterizing and/or subjective characterizing information for the aforementioned products.

Examples of objective characterizing information include, but are not limited to, ingredients information (i.e., specific components/materials from which the product is made), manufacturing locale information (such as country of origin, state of origin, municipality of origin, region of origin, and so forth), efficacy information (such as metrics regarding the relative effectiveness of the product to achieve a particular end-use result), cost information (such as per product, per ounce, per application or use, and so forth), availability information (such as present in-store availability, on-hand inventory availability at a relevant distribution center, likely or estimated shipping date, and so forth), environmental impact information (regarding, for example, the materials from which the product is made, one or more manufacturing processes by which the product is made, environmental impact associated with use of the product, and so forth), and so forth.

Examples of subjective characterizing information include but are not limited to user sensory perception information (regarding, for example, heaviness or lightness, speed of use, effort associated with use, smell, and so forth), aesthetics information (regarding, for example, how attractive or unattractive the product is in appearance, how well the product matches or accords with a particular design paradigm or theme, and so forth), trustworthiness information (regarding, for example, user perceptions regarding how likely the product is perceived to accomplish a particular purpose or to avoid causing a particular collateral harm), trendiness information, and so forth.

This information 1304 can be curated (or not), filtered, sorted, weighted (in accordance with a relative degree of trust, for example, accorded to a particular source of particular information), and otherwise categorized and utilized as desired. As one simple example in these regards, for some products it may be desirable to only use relatively fresh information (i.e., information not older than some specific cut-off date) while for other products it may be acceptable (or even desirable) to use, in lieu of fresh information or in combination therewith, relatively older information. As another simple example, it may be useful to use only information from one particular geographic region to characterize a particular product and to therefore not use information from other geographic regions.

At block 1303 the control circuit uses the foregoing information 1304 to form product characterization vectors for each of the plurality of different products. By one approach these product characterization vectors have a magnitude (for the length of the vector and/or the angle of the vector) that represents a reduction of exerted effort associated with the corresponding product to pursue a corresponding user partiality (as is otherwise discussed herein).

It is possible that a conflict will become evident as between various ones of the aforementioned items of information 1304. In particular, the available characterizations for a given product may not all be the same or otherwise in accord with one another. In some cases it may be appropriate to literally or effectively calculate and use an average to accommodate such a conflict. In other cases it may be useful to use one or more other predetermined conflict resolution rules 1305 to automatically resolve such conflicts when forming the aforementioned product characterization vectors.

These teachings will accommodate any of a variety of rules in these regards. By one approach, for example, the rule can be based upon the age of the information (where, for example the older (or newer, if desired) data is preferred or weighted more heavily than the newer (or older, if desired) data. By another approach, the rule can be based upon a number of user reviews upon which the user-based product characterization information is based (where, for example, the rule specifies that whichever user-based product characterization information is based upon a larger number of user reviews will prevail in the event of a conflict). By another approach, the rule can be based upon information regarding historical accuracy of information from a particular information source (where, for example, the rule specifies that information from a source with a better historical record of accuracy shall prevail over information from a source with a poorer historical record of accuracy in the event of a conflict).

By yet another approach, the rule can be based upon social media. For example, social media-posted reviews may be used as a tie-breaker in the event of a conflict between other more-favored sources. By another approach, the rule can be based upon a trending analysis. And by yet another approach the rule can be based upon the relative strength of brand awareness for the product at issue (where, for example, the rule specifies resolving a conflict in favor of a more favorable characterization when dealing with a product from a strong brand that evidences considerable consumer goodwill and trust).

It will be understood that the foregoing examples are intended to serve an illustrative purpose and are not offered as an exhaustive listing in these regards. It will also be understood that any two or more of the foregoing rules can be used in combination with one another to resolve the aforementioned conflicts.

By one approach the aforementioned product characterization vectors are formed to serve as a universal characterization of a given product. By another approach, however, the aforementioned information 1304 can be used to form product characterization vectors for a same characterization factor for a same product to thereby correspond to different usage circumstances of that same product. Those different usage circumstances might comprise, for example, different geographic regions of usage, different levels of user expertise (where, for example, a skilled, professional user might have different needs and expectations for the product than a casual, lay user), different levels of expected use, and so forth. In particular, the different vectorized results for a same characterization factor for a same product may have differing magnitudes from one another to correspond to different amounts of reduction of the exerted effort associated with that product under the different usage circumstances.

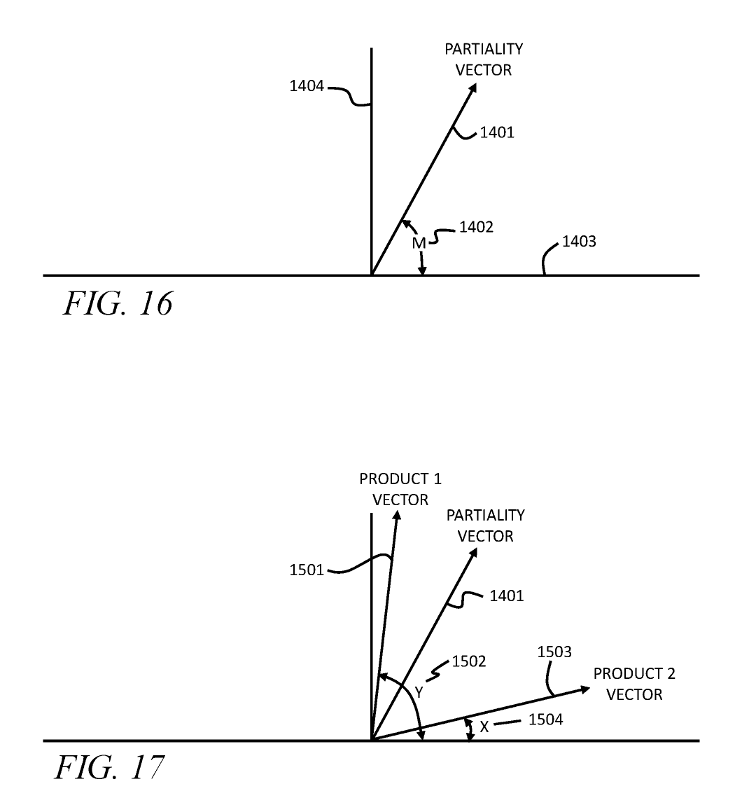

As noted above, the magnitude corresponding to a particular partiality vector for a particular person can be expressed by the angle of that partiality vector. FIG. 16 provides an illustrative example in these regards. In this example the partiality vector 1401 has an angle M 1402 (and where the range of available positive magnitudes range from a minimal magnitude represented by 0° (as denoted by reference numeral 1403) to a maximum magnitude represented by 90° (as denoted by reference numeral 1404)). Accordingly, the person to whom this partiality vector 1401 pertains has a relatively strong (but not absolute) belief in an amount of good that comes from an order associated with that partiality.

FIG. 17, in turn, presents that partiality vector 1401 in context with the product characterization vectors 1501 and 1503 for a first product and a second product, respectively. In this example the product characterization vector 1501 for the first product has an angle Y 1502 that is greater than the angle M 1402 for the aforementioned partiality vector 1401 by a relatively small amount while the product characterization vector 1503 for the second product has an angle X 1504 that is considerably smaller than the angle M 1402 for the partiality vector 1401.

Since, in this example, the angles of the various vectors represent the magnitude of the person's specified partiality or the extent to which the product aligns with that partiality, respectively, vector dot product calculations can serve to help identify which product best aligns with this partiality. Such an approach can be particularly useful when the lengths of the vectors are allowed to vary as a function of one or more parameters of interest. As those skilled in the art will understand, a vector dot product is an algebraic operation that takes two equal-length sequences of numbers (in this case, coordinate vectors) and returns a single number.

This operation can be defined either algebraically or geometrically. Algebraically, it is the sum of the products of the corresponding entries of the two sequences of numbers. Geometrically, it is the product of the Euclidean magnitudes of the two vectors and the cosine of the angle between them. The result is a scalar rather than a vector. As regards the present illustrative example, the resultant scaler value for the vector dot product of the product 1 vector 1501 with the partiality vector 1401 will be larger than the resultant scaler value for the vector dot product of the product 2 vector 1503 with the partiality vector 1401. Accordingly, when using vector angles to impart this magnitude information, the vector dot product operation provides a simple and convenient way to determine proximity between a particular partiality and the performance/properties of a particular product to thereby greatly facilitate identifying a best product amongst a plurality of candidate products.

By way of further illustration, consider an example where a particular consumer as a strong partiality for organic produce and is financially able to afford to pay to observe that partiality. A dot product result for that person with respect to a product characterization vector(s) for organic apples that represent a cost of $10 on a weekly basis (i.e., Cv·P1v) might equal (1,1), hence yielding a scalar result of ∥1∥ (where Cv refers to the corresponding partiality vector for this person and P1v represents the corresponding product characterization vector for these organic apples). Conversely, a dot product result for this same person with respect to a product characterization vector(s) for non-organic apples that represent a cost of $5 on a weekly basis (i.e., Cv·P2v) might instead equal (1,0), hence yielding a scalar result of ∥½∥. Accordingly, although the organic apples cost more than the non-organic apples, the dot product result for the organic apples exceeds the dot product result for the non-organic apples and therefore identifies the more expensive organic apples as being the best choice for this person.

To continue with the foregoing example, consider now what happens when this person subsequently experiences some financial misfortune (for example, they lose their job and have not yet found substitute employment). Such an event can present the “force” necessary to alter the previously-established “inertia” of this person's steady-state partialities; in particular, these negatively-changed financial circumstances (in this example) alter this person's budget sensitivities (though not, of course their partiality for organic produce as compared to non-organic produce). The scalar result of the dot product for the $5/week non-organic apples may remain the same (i.e., in this example, ∥½∥), but the dot product for the $10/week organic apples may now drop (for example, to ∥½∥ as well). Dropping the quantity of organic apples purchased, however, to reflect the tightened financial circumstances for this person may yield a better dot product result. For example, purchasing only $5 (per week) of organic apples may produce a dot product result of ∥1∥. The best result for this person, then, under these circumstances, is a lesser quantity of organic apples rather than a larger quantity of non-organic apples.

In a typical application setting, it is possible that this person's loss of employment is not, in fact, known to the system. Instead, however, this person's change of behavior (i.e., reducing the quantity of the organic apples that are purchased each week) might well be tracked and processed to adjust one or more partialities (either through an addition or deletion of one or more partialities and/or by adjusting the corresponding partiality magnitude) to thereby yield this new result as a preferred result.

The foregoing simple examples clearly illustrate that vector dot product approaches can be a simple yet powerful way to quickly eliminate some product options while simultaneously quickly highlighting one or more product options as being especially suitable for a given person.

Such vector dot product calculations and results, in turn, help illustrate another point as well. As noted above, sine waves can serve as a potentially useful way to characterize and view partiality information for both people and products/services. In those regards, it is worth noting that a vector dot product result can be a positive, zero, or even negative value. That, in turn, suggests representing a particular solution as a normalization of the dot product value relative to the maximum possible value of the dot product. Approached this way, the maximum amplitude of a particular sine wave will typically represent a best solution.

Taking this approach further, by one approach the frequency (or, if desired, phase) of the sine wave solution can provide an indication of the sensitivity of the person to product choices (for example, a higher frequency can indicate a relatively highly reactive sensitivity while a lower frequency can indicate the opposite). A highly sensitive person is likely to be less receptive to solutions that are less than fully optimum and hence can help to narrow the field of candidate products while, conversely, a less sensitive person is likely to be more receptive to solutions that are less than fully optimum and can help to expand the field of candidate products.

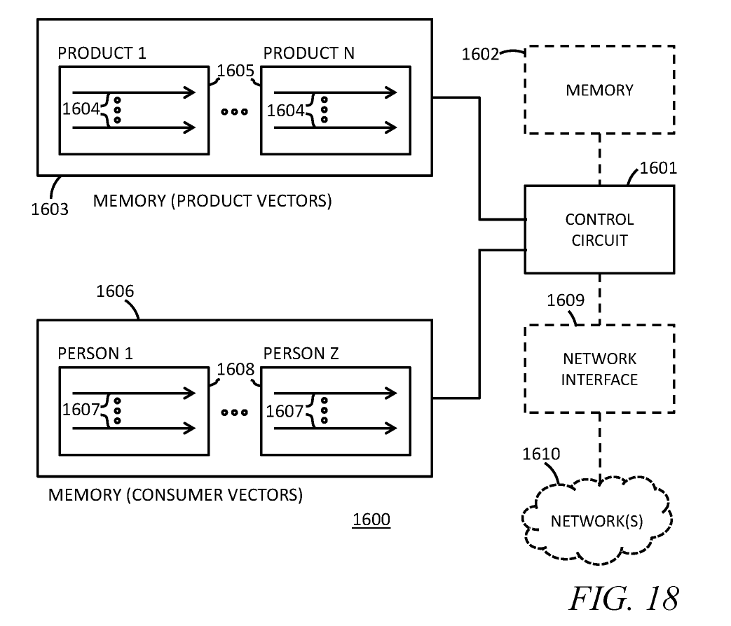

FIG. 18 presents an illustrative apparatus 1600 for conducting, containing, and utilizing the foregoing content and capabilities. In this particular example, the enabling apparatus 1600 includes a control circuit 1601. Being a “circuit,” the control circuit 1601 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 1601 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 1601 is configured (for example, by using corresponding programming as will be well understood by those skilled in the art) to carry out one or more of the steps, actions, and/or functions described herein.

By one optional approach the control circuit 1601 operably couples to a memory 1602. This memory 1602 may be integral to the control circuit 1601 or can be physically discrete (in whole or in part) from the control circuit 1601 as desired. This memory 1602 can also be local with respect to the control circuit 1601 (where, for example, both share a common circuit board, chassis, power supply, and/or housing) or can be partially or wholly remote with respect to the control circuit 1601 (where, for example, the memory 1602 is physically located in another facility, metropolitan area, or even country as compared to the control circuit 1601).

This memory 1602 can serve, for example, to non-transitorily store the computer instructions that, when executed by the control circuit 1601, cause the control circuit 1601 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

Either stored in this memory 1602 or, as illustrated, in a separate memory 1603 are the vectorized characterizations 1604 for each of a plurality of products 1605 (represented here by a first product through an Nth product where “N” is an integer greater than “1”). In addition, and again either stored in this memory 1602 or, as illustrated, in a separate memory 1606 are the vectorized characterizations 1607 for each of a plurality of individual persons 1608 (represented here by a first person through a Zth person wherein “Z” is also an integer greater than “1”).

In this example the control circuit 1601 also operably couples to a network interface 1609. So configured the control circuit 1601 can communicate with other elements (both within the apparatus 1600 and external thereto) via the network interface 1609. Network interfaces, including both wireless and non-wireless platforms, are well understood in the art and require no particular elaboration here. This network interface 1609 can compatibly communicate via whatever network or networks 1610 may be appropriate to suit the particular needs of a given application setting. Both communication networks and network interfaces are well understood areas of prior art endeavor and therefore no further elaboration will be provided here in those regards for the sake of brevity.

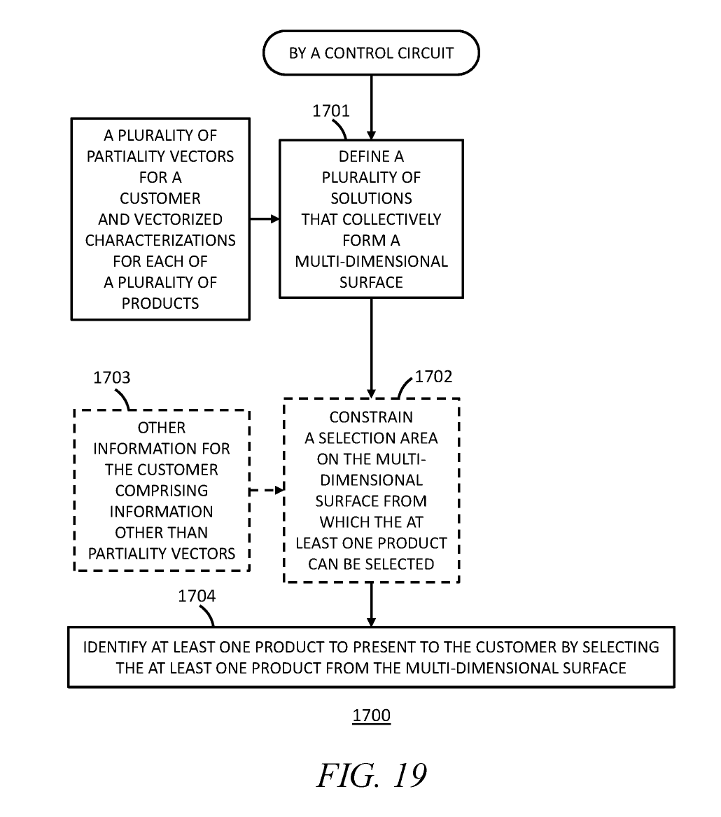

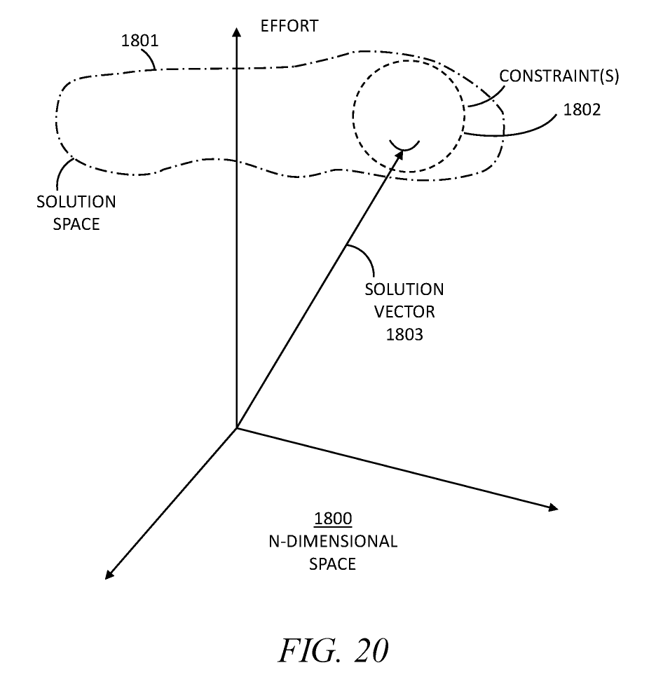

By one approach, and referring now to FIG. 19, the control circuit 1601 is configured to use the aforementioned partiality vectors 1607 and the vectorized product characterizations 1604 to define a plurality of solutions that collectively form a multidimensional surface (per block 1701). FIG. 20 provides an illustrative example in these regards. FIG. 20 represents an N-dimensional space 1800 and where the aforementioned information for a particular customer yielded a multi-dimensional surface denoted by reference numeral 1801. (The relevant value space is an N-dimensional space where the belief in the value of a particular ordering of one's life only acts on value propositions in that space as a function of a least-effort functional relationship.)

Generally speaking, this surface 1801 represents all possible solutions based upon the foregoing information. Accordingly, in a typical application setting this surface 1801 will contain/represent a plurality of discrete solutions. That said, and also in a typical application setting, not all of those solutions will be similarly preferable. Instead, one or more of those solutions may be particularly useful/appropriate at a given time, in a given place, for a given customer.

With continued reference to FIGS. 19 and 20, at optional block 1702 the control circuit 1601 can be configured to use information for the customer 1703 (other than the aforementioned partiality vectors 1607) to constrain a selection area 1802 on the multi-dimensional surface 1801 from which at least one product can be selected for this particular customer. By one approach, for example, the constraints can be selected such that the resultant selection area 1802 represents the best 95th percentile of the solution space. Other target sizes for the selection area 1802 are of course possible and may be useful in a given application setting.

The aforementioned other information 1703 can comprise any of a variety of information types. By one approach, for example, this other information comprises objective information. (As used herein, “objective information” will be understood to constitute information that is not influenced by personal feelings or opinions and hence constitutes unbiased, neutral facts.)

One particularly useful category of objective information comprises objective information regarding the customer. Examples in these regards include, but are not limited to, location information regarding a past, present, or planned/scheduled future location of the customer, budget information for the customer or regarding which the customer must strive to adhere (such that, by way of example, a particular product/solution area may align extremely well with the customer's partialities but is well beyond that which the customer can afford and hence can be reasonably excluded from the selection area 1802), age information for the customer, and gender information for the customer. Another example in these regards is information comprising objective logistical information regarding providing particular products to the customer. Examples in these regards include but are not limited to current or predicted product availability, shipping limitations (such as restrictions or other conditions that pertain to shipping a particular product to this particular customer at a particular location), and other applicable legal limitations (pertaining, for example, to the legality of a customer possessing or using a particular product at a particular location).

At block 1704 the control circuit 1601 can then identify at least one product to present to the customer by selecting that product from the multi-dimensional surface 1801. In the example of FIG. 20, where constraints have been used to define a reduced selection area 1802, the control circuit 1601 is constrained to select that product from within that selection area 1802. For example, and in accordance with the description provided herein, the control circuit 1601 can select that product via solution vector 1803 by identifying a particular product that requires a minimal expenditure of customer effort while also remaining compliant with one or more of the applied objective constraints based, for example, upon objective information regarding the customer and/or objective logistical information regarding providing particular products to the customer.

So configured, and as a simple example, the control circuit 1601 may respond per these teachings to learning that the customer is planning a party that will include seven other invited individuals. The control circuit 1601 may therefore be looking to identify one or more particular beverages to present to the customer for consideration in those regards. The aforementioned partiality vectors 1607 and vectorized product characterizations 1604 can serve to define a corresponding multi-dimensional surface 1801 that identifies various beverages that might be suitable to consider in these regards.

Objective information regarding the customer and/or the other invited persons, however, might indicate that all or most of the participants are not of legal drinking age. In that case, that objective information may be utilized to constrain the available selection area 1802 to beverages that contain no alcohol. As another example in these regards, the control circuit 1601 may have objective information that the party is to be held in a state park that prohibits alcohol and may therefore similarly constrain the available selection area 1802 to beverages that contain no alcohol.

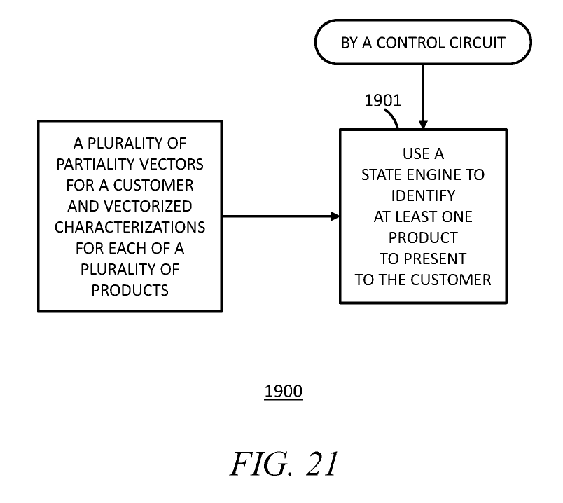

As described above, the aforementioned control circuit 1601 can utilize information including a plurality of partiality vectors for a particular customer along with vectorized product characterizations for each of a plurality of products to identify at least one product to present to a customer. By one approach 1900, and referring to FIG. 21, the control circuit 1601 can be configured as (or to use) a state engine to identify such a product (as indicated at block 1901). As used herein, the expression “state engine” will be understood to refer to a finite-state machine, also sometimes known as a finite-state automaton or simply as a state machine.

Generally speaking, a state engine is a basic approach to designing both computer programs and sequential logic circuits. A state engine has only a finite number of states and can only be in one state at a time. A state engine can change from one state to another when initiated by a triggering event or condition often referred to as a transition. Accordingly, a particular state engine is defined by a list of its states, its initial state, and the triggering condition for each transition.

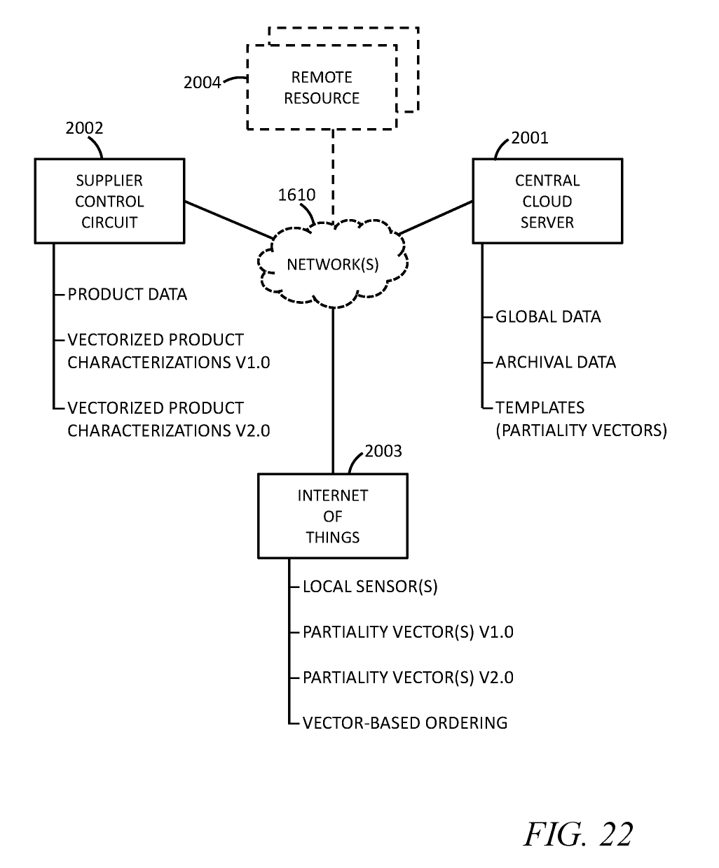

It will be appreciated that the apparatus 1600 described above can be viewed as a literal physical architecture or, if desired, as a logical construct. For example, these teachings can be enabled and operated in a highly centralized manner (as might be suggested when viewing that apparatus 1600 as a physical construct) or, conversely, can be enabled and operated in a highly decentralized manner. FIG. 22 provides an example as regards the latter.

In this illustrative example a central cloud server 2001, a supplier control circuit 2002, and the aforementioned Internet of Things 2003 communicate via the aforementioned network 1610.

The central cloud server 2001 can receive, store, and/or provide various kinds of global data (including, for example, general demographic information regarding people and places, profile information for individuals, product descriptions and reviews, and so forth), various kinds of archival data (including, for example, historical information regarding the aforementioned demographic and profile information and/or product descriptions and reviews), and partiality vector templates as described herein that can serve as starting point general characterizations for particular individuals as regards their partialities. Such information may constitute a public resource and/or a privately-curated and accessed resource as desired. (It will also be understood that there may be more than one such central cloud server 2001 that store identical, overlapping, or wholly distinct content.)

The supplier control circuit 2002 can comprise a resource that is owned and/or operated on behalf of the suppliers of one or more products (including but not limited to manufacturers, wholesalers, retailers, and even resellers of previously-owned products). This resource can receive, process and/or analyze, store, and/or provide various kinds of information. Examples include but are not limited to product data such as marketing and packaging content (including textual materials, still images, and audio-video content), operators and installers manuals, recall information, professional and non-professional reviews, and so forth.

Another example comprises vectorized product characterizations as described herein. More particularly, the stored and/or available information can include both prior vectorized product characterizations (denoted in FIG. 22 by the expression “vectorized product characterizations V1.0”) for a given product as well as subsequent, updated vectorized product characterizations (denoted in FIG. 22 by the expression “vectorized product characterizations V2.0”) for the same product. Such modifications may have been made by the supplier control circuit 2002 itself or may have been made in conjunction with or wholly by an external resource as desired.

The Internet of Things 2003 can comprise any of a variety of devices and components that may include local sensors that can provide information regarding a corresponding user's circumstances, behaviors, and reactions back to, for example, the aforementioned central cloud server 2001 and the supplier control circuit 2002 to facilitate the development of corresponding partiality vectors for that corresponding user. Again, however, these teachings will also support a decentralized approach. In many cases devices that are fairly considered to be members of the Internet of Things 2003 constitute network edge elements (i.e., network elements deployed at the edge of a network). In some case the network edge element is configured to be personally carried by the person when operating in a deployed state. Examples include but are not limited to so-called smart phones, smart watches, fitness monitors that are worn on the body, and so forth. In other cases, the network edge element may be configured to not be personally carried by the person when operating in a deployed state. This can occur when, for example, the network edge element is too large and/or too heavy to be reasonably carried by an ordinary average person. This can also occur when, for example, the network edge element has operating requirements ill-suited to the mobile environment that typifies the average person.

For example, a so-called smart phone can itself include a suite of partiality vectors for a corresponding user (i.e., a person that is associated with the smart phone which itself serves as a network edge element) and employ those partiality vectors to facilitate vector-based ordering (either automated or to supplement the ordering being undertaken by the user) as is otherwise described herein. In that case, the smart phone can obtain corresponding vectorized product characterizations from a remote resource such as, for example, the aforementioned supplier control circuit 2002 and use that information in conjunction with local partiality vector information to facilitate the vector-based ordering.

Also, if desired, the smart phone in this example can itself modify and update partiality vectors for the corresponding user. To illustrate this idea in FIG. 22, this device can utilize, for example, information gained at least in part from local sensors to update a locally-stored partiality vector (represented in FIG. 22 by the expression “partiality vector V1.0”) to obtain an updated locally-stored partiality vector (represented in FIG. 22 by the expression “partiality vector V2.0”). Using this approach, a user's partiality vectors can be locally stored and utilized. Such an approach may better comport with a particular user's privacy concerns.

It will be understood that the smart phone employed in the immediate example is intended to serve in an illustrative capacity and is not intended to suggest any particular limitations in these regards. In fact, any of a wide variety of Internet of Things devices/components could be readily configured in the same regards. As one simple example in these regards, a computationally-capable networked refrigerator could be configured to order appropriate perishable items for a corresponding user as a function of that user's partialities.

Presuming a decentralized approach, these teachings will accommodate any of a variety of other remote resources 2004. These remote resources 2004 can, in turn, provide static or dynamic information and/or interaction opportunities or analytical capabilities that can be called upon by any of the above-described network elements. Examples include but are not limited to voice recognition, pattern and image recognition, facial recognition, statistical analysis, computational resources, encryption and decryption services, fraud and misrepresentation detection and prevention services, digital currency support, and so forth.

As already suggested above, these approaches provide powerful ways for identifying products and/or services that a given person, or a given group of persons, may likely wish to buy to the exclusion of other options. When the magnitude and direction of the relevant/required meta-force vector that comes from the perceived effort to impose order is known, these teachings will facilitate, for example, engineering a product or service containing potential energy in the precise ordering direction to provide a total reduction of effort. Since people generally take the path of least effort (consistent with their partialities) they will typically accept such a solution.

As one simple illustrative example, a person who exhibits a partiality for food products that emphasize health, natural ingredients, and a concern to minimize sugars and fats may be presumed to have a similar partiality for pet foods because such partialities may be based on a value system that extends beyond themselves to other living creatures within their sphere of concern. If other data is available to indicate that this person in fact has, for example, two pet dogs, these partialities can be used to identify dog food products having well-aligned vectors in these same regards. This person could then be solicited to purchase such dog food products using any of a variety of solicitation approaches (including but not limited to general informational advertisements, discount coupons or rebate offers, sales calls, free samples, and so forth).

As another simple example, the approaches described herein can be used to filter out products/services that are not likely to accord well with a given person's partiality vectors. In particular, rather than emphasizing one particular product over another, a given person can be presented with a group of products that are available to purchase where all of the vectors for the presented products align to at least some predetermined degree of alignment/accord and where products that do not meet this criterion are simply not presented.

And as yet another simple example, a particular person may have a strong partiality towards both cleanliness and orderliness. The strength of this partiality might be measured in part, for example, by the physical effort they exert by consistently and promptly cleaning their kitchen following meal preparation activities. If this person were looking for lawn care services, their partiality vector(s) in these regards could be used to identify lawn care services who make representations and/or who have a trustworthy reputation or record for doing a good job of cleaning up the debris that results when mowing a lawn. This person, in turn, will likely appreciate the reduced effort on their part required to locate such a service that can meaningfully contribute to their desired order.

These teachings can be leveraged in any number of other useful ways. As one example in these regards, various sensors and other inputs can serve to provide automatic updates regarding the events of a given person's day. By one approach, at least some of this information can serve to help inform the development of the aforementioned partiality vectors for such a person. At the same time, such information can help to build a view of a normal day for this particular person. That baseline information can then help detect when this person's day is going experientially awry (i.e., when their desired “order” is off track). Upon detecting such circumstances these teachings will accommodate employing the partiality and product vectors for such a person to help make suggestions (for example, for particular products or services) to help correct the day's order and/or to even effect automatically-engaged actions to correct the person's experienced order.

When this person's partiality (or relevant partialities) are based upon a particular aspiration, restoring (or otherwise contributing to) order to their situation could include, for example, identifying the order that would be needed for this person to achieve that aspiration. Upon detecting, (for example, based upon purchases, social media, or other relevant inputs) that this person is aspirating to be a gourmet chef, these teachings can provide for plotting a solution that would begin providing/offering additional products/services that would help this person move along a path of increasing how they order their lives towards being a gourmet chef.

By one approach, these teachings will accommodate presenting the consumer with choices that correspond to solutions that are intended and serve to test the true conviction of the consumer as to a particular aspiration. The reaction of the consumer to such test solutions can then further inform the system as to the confidence level that this consumer holds a particular aspiration with some genuine conviction. In particular, and as one example, that confidence can in turn influence the degree and/or direction of the consumer value vector(s) in the direction of that confirmed aspiration.

All the above approaches are informed by the constraints the value space places on individuals so that they follow the path of least perceived effort to order their lives to accord with their values which results in partialities. People generally order their lives consistently unless and until their belief system is acted upon by the force of a new trusted value proposition. The present teachings are uniquely able to identify, quantify, and leverage the many aspects that collectively inform and define such belief systems.

A person's preferences can emerge from a perception that a product or service removes effort to order their lives according to their values. The present teachings acknowledge and even leverage that it is possible to have a preference for a product or service that a person has never heard of before in that, as soon as the person perceives how it will make their lives easier they will prefer it. Most predictive analytics that use preferences are trying to predict a decision the customer is likely to make. The present teachings are directed to calculating a reduced effort solution that can/will inherently and innately be something to which the person is partial.

Accordingly, in one aspect of the packing plan, the storage locations may be arranged, at least in part, by customer and/or product value vectors. As described, in one form, products may be arranged in dense storage units and storage locations according to value vectors assigned to those products. For example, products that have one or more similar value vectors may be arranged in the same dense storage unit. In another form, as another example, where customer preference information is available and stored in a database, products may be arranged in the same storage unit for a particular customer according to the value vectors for that customer. Alternatively, the packing plan may consider known customer value vectors based on demographic characteristics for a specific geographic region and determine corresponding products for that region having similar or matching value vectors. Additional packing plans involving the use of value vectors may also be applied.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

This application is related to, and incorporates herein by reference in its entirety, each of the following U.S. applications listed as follows by application number and filing date: 62/323,026 filed Apr. 15, 2016; 62/341,993 filed May 26, 2016; 62/348,444 filed Jun. 10, 2016; 62/350,312 filed Jun. 15, 2016; 62/350,315 filed Jun. 15, 2016; 62/351,467 filed Jun. 17, 2016; 62/351,463 filed Jun. 17, 2016; 62/352,858 filed Jun. 21, 2016; 62/356,387 filed Jun. 29, 2016; 62/356,374 filed Jun. 29, 2016; 62/356,439 filed Jun. 29, 2016; 62/356,375 filed Jun. 29, 2016; 62/358,287 filed Jul. 5, 2016; 62/360,356 filed Jul. 9, 2016; 62/360,629 filed Jul. 11, 2016; 62/365,047 filed Jul. 21, 2016; 62/367,299 filed Jul. 27, 2016; 62/370,853 filed Aug. 4, 2016; 62/370,848 filed Aug. 4, 2016; 62/377,298 filed Aug. 19, 2016; 62/377,113 filed Aug. 19, 2016; 62/380,036 filed Aug. 26, 2016; 62/381,793 filed Aug. 31, 2016; 62/395,053 filed Sep. 15, 2016; 62/397,455 filed Sep. 21, 2016; 62/400,302 filed Sep. 27, 2016; 62/402,068 filed Sep. 30, 2016; 62/402,164 filed Sep. 30, 2016; 62/402,195 filed Sep. 30, 2016; 62/402,651 filed Sep. 30, 2016; 62/402,692 filed Sep. 30, 2016; 62/402,711 filed Sep. 30, 2016; 62/406,487 filed Oct. 11, 2016; 62/408,736 filed Oct. 15, 2016; 62/409,008 filed Oct. 17, 2016; 62/410,155 filed Oct. 19, 2016; 62/413,312 filed Oct. 26, 2016; 62/413,304 filed Oct. 26, 2016; 62/413,487 filed Oct. 27, 2016; 62/422,837 filed Nov. 16, 2016; 62/423,906 filed Nov. 18, 2016; 62/424,661 filed Nov. 21, 2016; 62/427,478 filed Nov. 29, 2016; 62/436,842 filed Dec. 20, 2016; 62/436,885 filed Dec. 20, 2016; 62/436,791 filed Dec. 20, 2016; 62/439,526 filed Dec. 28, 2016; 62/442,631 filed Jan. 5, 2017; 62/445,552 filed Jan. 12, 2017; 62/463,103 filed Feb. 24, 2017; 62/465,932 filed Mar. 2, 2017; 62/467,546 filed Mar. 6, 2017; 62/467,968 filed Mar. 7, 2017; 62/467,999 filed Mar. 7, 2017; 62/471,804 filed Mar. 15, 2017; 62/471,830 filed Mar. 15, 2017; 62/479,525 filed Mar. 31, 2017; 62/480,733 filed Apr. 3, 2017; 62/482,863 filed Apr. 7, 2017; 62/482,855 filed Apr. 7, 2017; 62/485,045 filed Apr. 13, 2017; Ser. No. 15/487,760 filed Apr. 14, 2017; Ser. No. 15/487,538 filed Apr. 14, 2017; Ser. No. 15/487,775 filed Apr. 14, 2017; Ser. No. 15/488,107 filed Apr. 14, 2017; Ser. No. 15/488,015 filed Apr. 14, 2017; Ser. No. 15/487,728 filed Apr. 14, 2017; Ser. No. 15/487,882 filed Apr. 14, 2017; Ser. No. 15/487,826 filed Apr. 14, 2017; Ser. No. 15/487,792 filed Apr. 14, 2017; Ser. No. 15/488,004 filed Apr. 14, 2017; Ser. No. 15/487,894 filed Apr. 14, 2017; 62/486,801, filed Apr. 18, 2017; 62/510,322, filed May 24, 2017; 62/510,317, filed May 24, 2017; Ser. No. 15/606,602, filed May 26, 2017; 62/513,490, filed Jun. 1, 2017; Ser. No. 15/624,030 filed Jun. 15, 2017; Ser. No. 15/625,599 filed Jun. 16, 2017; Ser. No. 15/628,282 filed Jun. 20, 2017; 62/523,148 filed Jun. 21, 2017; 62/525,304 filed Jun. 27, 2017; Ser. No. 15/634,862 filed Jun. 27, 2017; 62/527,445 filed Jun. 30, 2017; Ser. No. 15/655,339 filed Jul. 20, 2017; Ser. No. 15/669,546 filed Aug. 4, 2017; and 62/542,664 filed Aug. 8, 2017; 62/542,896 filed Aug. 9, 2017; Ser. No. 15/678,608 filed Aug. 16, 2017; 62/548,503 filed Aug. 22, 2017; 62/549,484 filed Aug. 24, 2017; Ser. No. 15/685,981 filed Aug. 24, 2017; 62/558,420 filed Sep. 14, 2017; Ser. No. 15/704,878 filed Sep. 14, 2017; and 62/559,128 filed Sep. 15, 2017.

What is claimed is:

1. A system for storing and retrieving merchandise items in distribution centers, the system comprising:
a distribution center with a plurality of storage locations holding a plurality of merchandise items, the plurality of merchandise items being arranged in the plurality of storage locations according to a predetermined packing plan, the plan assigning a unique storage location to each merchandise item;
a plurality of sensor tags associated with the plurality of merchandise items, each sensor tag being associated with a type of merchandise item;
a plurality of routes from the plurality of storage locations to at least one merchandise handling area;
at least one tote configured to deliver merchandise items from the plurality of storage locations to the at least one merchandise handling area;
a first control circuit operatively coupled to the plurality of sensor tags and to the at least one tote, the first control circuit configured to:
determine a first type of merchandise item to be delivered to the at least one merchandise handling area;
communicate with a first sensor tag to identify a first storage location of the first type of merchandise item;
communicate with a first tote to move the first tote to the first storage location to receive the first type of merchandise item; and
communicate with the first tote to move the first tote to the at least one merchandise handling area;
wherein the plurality of storage locations in the predetermined packing plan are arranged based on at least one of merchandise item type, customer information, delivery distance, projected storage time, delivery time, and weather.

2. The system of claim 1, wherein the plurality of storage locations are arranged in at least one storage unit having a plurality of compartments, each compartment having unique coordinates to identify the location of the compartment within the at least one storage unit.

3. The system of claim 1, wherein the at least one tote comprises a second control circuit configured to:
receive a communication from the first control circuit regarding the first storage location of the first type of merchandise item; and
determine a route to the first storage location and move the tote to the first storage location.

4. The system of claim 3, wherein the at least one tote further comprises a sensor and wherein the second control circuit is configured to:
communicate with a database to determine a first identifier for the first type of merchandise item; and
actuate the sensor to compare a second identifier for a merchandise item received at the first storage location with the first identifier to verify that the merchandise item received is of the first type.

5. The system of claim 1, wherein the first control circuit is configured to:
determine a second type of merchandise item to be delivered to the at least one merchandise handling area;
communicate with a second sensor tag to identify a second storage location of the second type of merchandise item; and
communicate with the first tote to move the first tote from the first storage location to the second storage location to receive the second type of merchandise.

6. The system of claim 1, wherein the at least one tote further comprises a two-way wireless communications component that is attached to the tote and configured to receive information regarding a first planned automated route for the at least one tote to the first storage location.

7. The system of claim 6, wherein the two-way wireless communications component is configured to receive information regarding the first type of merchandise item planned to be placed in the at least one tote at the first storage location.

8. The system of claim 7, wherein the at least one tote further comprises a first sensor to verify contents or condition of the first type of merchandise item planned to be placed in the at least one tote.

9. The system of claim 7, wherein:
the at least one tote further comprises a second sensor for reading the first sensor tag to determine the identity of the first type of merchandise item in the first storage location; and
the two-way wireless communications component is configured to transmit the read information to the control circuit to verify that the first type of merchandise item is in the corresponding storage location according to the predetermined packing plan.

10. The system of claim 7, wherein the two-way wireless communications component is configured to receive information regarding a second planned automated route for the at least one tote to the at least one merchandise handling area.

11. The system of claim 1, further comprising an unloading apparatus configured to transport the first type of merchandise item from the first storage location to the first tote.

12. The system of claim 1, wherein the predetermined packing plan is determined based on customer preferences.

13. The system of claim 12, wherein the first control circuit is configured to:
access partiality information for customers and to use that partiality information to form corresponding partiality vectors for customers wherein the partiality vector has a magnitude that corresponds to a magnitude of the customer's belief in an amount of good that comes from an order associated with that partiality.

14. The system of claim 13, wherein the first control circuit is further configured to:
form counterpart merchandise item vectors wherein the counterpart vectors have a magnitude that represents to the degree which each of the merchandise items pursues a corresponding partiality.

15. The system of claim 14, wherein the first control circuit is further configured to:
use the partiality vectors and the merchandise item vectors to determine the predetermined packing plan.

16. The system of claim 1, wherein the plurality of sensor tags comprise RFID tags or barcodes.

17. A method for storing and retrieving merchandise items in distribution centers, the method comprising:
providing a distribution center with a plurality of storage locations holding a plurality of merchandise items;
arranging the plurality of merchandise items in the plurality of storage locations according to a predetermined packing plan, the plan assigning a unique storage location to each merchandise item, the arrangement of the plurality of storage locations being based on at least one of merchandise item type, customer information, delivery distance, projected storage time, delivery time, and weather;
associating a plurality of sensor tags with the plurality of merchandise items, each sensor tag being associated with a type of merchandise item;
providing a plurality of routes from the plurality of storage locations to at least one merchandise handling area;
providing at least one tote configured to deliver merchandise items from the plurality of storage locations to the at least one merchandise handling area;
identifying a first type of merchandise item to be delivered to the at least one merchandise handling area;
communicating with a first sensor tag to identify a first storage location of the first type of merchandise item;
communicating with a first tote to move the first tote to the first storage location to receive the first type of merchandise item; and
communicating with the first tote to move the first tote to the at least one merchandise handling area.

18. The method of claim 17, further comprising:
determining a second type of merchandise item to be delivered to the at least one merchandise handling area;
communicating with a second sensor tag to identify a second storage location of the second type of merchandise item; and
communicating with the first tote to move the first tote from the first storage location to the second storage location to receive the second type of merchandise.

19. The method of claim 17, further comprising receiving information regarding a first planned automated route for the at least one tote to the first storage location.

20. The method of claim 17, further comprising verifying contents or condition of the first type of merchandise item planned to be placed in the at least one tote at the first storage location.

21. The method of claim 17, further comprising:
reading the first sensor tag to determine the identity of the first type of merchandise item in the first storage location; and
transmitting the read information to the control circuit to verify that the first type of merchandise item is in the corresponding storage location according to the predetermined packing plan.

22. The method of claim 17, wherein the predetermined packing plan is determined based on customer preferences.

23. The method of claim 22, further comprising:
accessing partiality information for customers and using that partiality information to form corresponding partiality vectors for customers wherein the partiality vector has a magnitude that corresponds to a magnitude of the customer's belief in an amount of good that comes from an order associated with that partiality;
forming counterpart merchandise item vectors wherein the counterpart vectors have a magnitude that represents to the degree which each of the merchandise items pursues a corresponding partiality; and
using the partiality vectors and the merchandise item vectors to determine the predetermined packing plan.
